(19) United States
(12) Patent Application Publication
(10) Pub. No.: US 2016/0016207 A1
(43) Pub. Date: Jan. 21, 2016

(54) WASHING DEVICE, HIGH-PRESSURE WASHING DEVICE, AND ADAPTER

(71) Applicant: HITACHI KOKI CO., LTD., Minato-ku, Tokyo (JP)

(72) Inventors: Noriyuki Horie, Hitachinaka (JP); Junichi Kamimura, Hitachinaka (JP); Shinichirou Satou, Hitachinaka (JP); Tomomasa Nishikawa, Hitachinaka (JP)

(21) Appl. No.: 14/378,705

(22) PCT Filed: Feb. 14, 2013
(86) PCT No.: PCT/JP13/00801

§ 371 Date: Aug. 14, 2014

(30) Foreign Application Priority Data
Feb. 17, 2012 (JP) 2012-033403
Feb. 17, 2012 (JP) 2012-033404
Feb. 17, 2012 (JP) 2012-033405
Feb. 17, 2012 (JP) 2012-033406

(51) Int. Cl. B08B 3/02; F16L 25/00

(52) U.S. Cl. CPC B08B 3/026; F16L 25/0018

(57) ABSTRACT

A high-pressure washing device (1) includes a nozzle (31). The nozzle (31) is configured to eject a high-pressure cleaning liquid. The cleaning liquid ejected from the nozzle (31) has a pulsation pressure. A variation rate of the pulsation pressure is more than or equal to 20%.

### TECHNICAL FIELD

The present invention relates to a washing device, a high-pressure washing device and an adapter provided in the same.

### BACKGROUND ART

Conventionally, as a high-pressure washing device for cleaning an outer wall such as a concrete wall or a tile wall, or a car, there is commonly used a stationary type washing device which includes a pump driven by electric power supplied from a commercial power supply, and, which compresses water (cleaning liquid) supplied from a tap (water source) by means of the pump and ejects the water. The pump is a three-plunger system in which three reciprocating members are provided (For example, refer to Japan Patent Application Publication No. 2005-313008).

### DISCLOSURE OF INVENTION

### Solution to Problem

However, in the three-plunger system, cleaning liquid is ejected with substantially no pulsation, so that electric power and cleaning liquid are wasted.

Further, in the three-plunger system, a size of the pump itself is disadvantageously increased and, accordingly, a size of a drive section including the pump is disadvantageously increased depending on arrangement of the plunger and a motor.

Further, most existing washing device uses cleaning liquid (water) supplied from waterworks, and there is no high-pressure washing device that can use cleaning liquid supplied from a plurality of sources such as a commercially-available PET bottle or plastic container, as well as tap water.

Further, cleaning operation performed by the above washing device requires ensuring of both the commercial power supply and water source. Further, even if both the commercial power supply and water source can be ensured, a cleaning area of the washing device is restricted by a length of a power cable or a water hose.

In order to ensure a sufficient cleaning area, a configuration in which the cleaning liquid is contained in a container for portability purposes is considered. However, if the container is damaged in the configuration in which the container is attached to the washing device, the cleaning liquid may leak to disable cleaning operation. Further, although containing the cleaning liquid in the container allows the washing device to be carried about without any concern for the water source, a shape and size of the washing device need to be adapted to portability.

In view of forgoing, it is an object of the present invention to provide a high-pressure washing device capable of suppressing the waste of electric power and cleaning liquid. Another object of the present invention is to provide a washing device capable of using cleaning liquid supplied from a plurality of sources. A still another object of the present invention is to provide a high-pressure washing device capable of suppressing the waste of the cleaning liquid. A still another object of the present invention is to provide a high-pressure washing device capable of reducing a size thereof. A still another object of the present invention is therefore to provide a washing device capable of performing cleaning operation over a wide area. A still another object of the present invention is to provide a washing device excellent in portability and capable of performing high-pressure cleaning. A still another object of the present invention is to provide a washing device capable of preventing the container from being damaged and excellent in portability.

In order to attain above and other object, the present invention provide a high-pressure washing device. A high-pressure washing device includes a nozzle configured to eject a high-pressure cleaning liquid. The cleaning liquid ejected from the nozzle has a pulsation pressure. A variation rate of the pulsation pressure is more than or equal to 20%.

This configuration allows high-pressure cleaning to be performed while suppressing electric power consumption and cleaning liquid consumption.

According to another aspect, the present invention provides a high-pressure washing device. The high-pressure washing device includes a nozzle, a motor, and a drive section. The nozzle is configured to eject a high-pressure cleaning liquid. The drive section includes a pump. The pump is a reciprocating pump having one or two reciprocating members driven by the motor.

According to the above configuration, the drive section is constituted by the reciprocating pump having one or two reciprocating member, so that the drive section is made compact to reduce a size of the device itself.

According to still another aspect, the present invention provides a high-pressure washing device. The high-pressure washing device includes a nozzle, a motor, and a pump. The nozzle is configured to eject a high-pressure cleaning liquid. The pump is configured to be reciprocatingly driven by the motor to convey the cleaning liquid to the nozzle. The pump is configured to instantaneously eject from the nozzle the cleaning liquid having a pressure more than or equal to a pressure of waterworks.

With this configuration, the high-pressure cleaning liquid is configured to be ejected instantaneously, not continuously, thereby suppressing waste of the cleaning liquid as compared to the conventional three-plunger system.

According to still another aspect, the present invention provides a washing device. The washing device includes a handle portion, and a drive section. The washing device is configured to eject a cleaning liquid from a nozzle. The drive section is configured to be driven so as to eject the cleaning liquid from the nozzle. The washing device further includes a tank accommodating portion configured to accommodate a tank therein. The tank accommodating portion is disposed below the handle section. The drive section is disposed below the tank accommodating section. The handle portion, the tank accommodating portion, and the drive section are arranged from top to bottom in this order.

This configuration can prevent the tank from being damaged when the washing device is overturned or dropped. Further, this configuration can prevent the cleaning liquid from leaking from the tank accommodating portion even when a water-feed inlet is damaged. The washing device is provided with the tank, thereby eliminating the need for connection with a water hose, which allows use over a wide area.

According to still another aspect, the present invention provides a washing device. The washing device includes a nozzle, and a motor. The nozzle is configured to eject a cleaning liquid. The housing is configured to detachably receive a tank for accommodating therein the cleaning liquid. The motor is accommodated in the housing. The washing device further includes a pump configured to be driven by the motor to convey the cleaning liquid accommodated in the tank to the nozzle.

According to the above configuration, the tank is detachably attached to the high-pressure washing device, thereby eliminating the need for connection to a water hose. This allows high-pressure cleaning to be performed over a wide range without being restricted by a length of the water hose.

According to still another aspect, the present invention provides a washing device. The washing device includes a motor, a pump and a housing. The pump is driven by the motor. The housing is for accommodating therein the motor and the pump. The washing device further includes a connecting portion provided at the housing. The connecting portion is configured to be connected to a tank for accommodating therein a cleaning liquid. The housing is configured to detachably receive a plurality of types of tanks. The connecting portion is connectable to the plurality of types of tanks.

According to still another aspect, the present invention provides a washing device. The washing device includes a tank and a connecting portion. The washing device is configured to eject a cleaning liquid from a nozzle. The tank is configured to accommodate therein a cleaning liquid. The connecting portion is configured to be connected to the tank. The washing device further includes an adapter configured to connect the tank to the connecting portion. The tank is formed with an opening portion. The adapter includes a tank-side engagement portion engageable with the opening portion and a device-side engagement portion engageable with the connecting portion.

With this configuration, large-capacity and small-capacity containers can be used depending on intended use.

According to still another aspect, the present invention provides a washing device. The washing device includes a tank and an adapter. The washing device is configured to eject a cleaning liquid from a nozzle. The tank is configured to accommodate therein the cleaning liquid. The adapter unit is configured to be connected to the tank. The adapter unit is connectable to a plurality of types of tanks including a first tank formed with a first opening, and a second tank formed with a second opening having a size different from a size of the first opening. The adapter unit includes a first adapter connectable to the first tank and a second adapter connectable to the second tank.

With this configuration, various types of tanks can be used, improving workability.

According to still another aspect, the present invention provides an adapter. The adapter is configured to connect a tank for accommodating a cleaning liquid to a washing device configured to eject the cleaning liquid form a nozzle. The tank is formed with an opening portion. The tank includes a tank-side engagement portion and a device-side engagement portion. The tank-side engagement portion is engageable with the opening portion. The device-side engagement portion is engageable with the washing device.

With this configuration, the washing device and commercially-available container can be connected to each other through the adapter, thereby allowing the commercially-available container to be used as the container of the washing device. This allows an appropriate container to be selected in accordance with use amount and use time. Further, the use of a plurality of types of adopters allows high-pressure cleaning to be performed in various scenes with the washing device

According to the present invention, a high-pressure washing device can suppress the waste of electric power and cleaning liquid. Further, a washing device can use cleaning liquid supplied from a plurality of sources. Further, a high-pressure washing device can suppress the waste of the cleaning liquid. Further, a high-pressure washing device can reduce a size thereof. Further, a washing device can perform cleaning operation over a wide area. Further, a washing device can possess excellent portability and perform high-pressure cleaning. Further, a washing device can prevent the tank from being damaged and possess excellent portability.

### BRIEF DESCRIPTION OF DRAWINGS

FIG. 1 is an overall schematic perspective view of a high-pressure washing device according to a first embodiment of the invention.

FIG. 2 is a cross-sectional view of the high-pressure washing device according to the first embodiment of the invention.

FIG. 3 is a cross-sectional view of the high-pressure washing device with a lid portion open according to the first embodiment of the invention.

FIG. 4 is an enlarged cross-sectional view showing a state where a tank is about to being engaged with an upper housing and a tank according to the first embodiment of the invention.

FIG. 5 is an enlarged cross-sectional view showing a state where the tank is completely engaged with the upper housing according to the first embodiment of the invention.

FIG. 6 is a cross-sectional view of a lower housing according to the first embodiment of the invention.

FIG. 7 is a cross-sectional view of the lower housing when a battery pack is attached to or detached from a battery chamber according to the first embodiment of the invention.

FIG. 8 is a cross-sectional view of a pump chamber when a plunger is positioned at a bottom dead point according to the first embodiment of the invention.

FIG. 9 is a cross-sectional view of the pump chamber when the plunger is positioned at a top dead point according to the first embodiment of the invention.

FIG. 10 is a graph showing an ejection waveform of a conventional three-plunger type pump.

FIG. 11 is a graph showing a theoretical ejection waveform of the high-pressure washing device according to the first embodiment of the invention.

FIG. 12 is a graph showing an actual ejection waveform of the high-pressure washing device according to the first embodiment of the invention.

FIG. 13 is an overall schematic perspective view of a high-pressure washing device according to a second embodiment of the invention.

FIG. 14 is a schematic perspective view of the high-pressure washing device when a housing is separated from a tank according to the second embodiment of the invention.

FIG. 15 is a partial cross-sectional view of the high-pressure washing device when the housing is attached to the tank according to the second embodiment of the invention.

FIG. 16 is a partial cross-sectional view of the high-pressure washing device when the housing is separated from the tank according to the second embodiment of the invention.

FIG. 17 is an overall cross-sectional view of the high-pressure washing device according to the second embodiment of the invention.

FIG. 18 is a partial enlarged cross-sectional view showing a connection between a battery cover and a battery chamber according to the second embodiment of the invention.

FIG. 19 is a schematic perspective view of the housing when a battery pack is attached to or detached from the battery chamber according to the second embodiment of the invention.

FIG. 20 is a partial cross-sectional view of the battery pack according to the second embodiment of the invention.

FIG. 21 is a schematic perspective view of the housing when the battery pack is attached to the battery chamber according to the second embodiment of the invention.

FIG. 22 is an overall schematic perspective view of a high-pressure washing device when a housing is attached to a plastic tank according to a third embodiment of the invention.

FIG. 23 is an overall cross-sectional view of the high-pressure washing device when the housing is attached to the plastic tank according to the third embodiment of the invention.

FIG. 24 is an overall schematic perspective view of the high-pressure washing device when the housing is attached to a PET bottle according to the third embodiment of the invention.

FIG. 25 is an overall cross-sectional view of the high-pressure washing device when the housing is attached to the PET bottle according to the third embodiment of the invention.

FIG. 26 is a side view of a high-pressure washing device when a housing is attached to a PET bottle according to a fourth embodiment of the invention.

FIG. 27 is an overall cross-sectional view of the high-pressure washing device when a locking portion of an adapter is unlocked according to the fourth embodiment of the invention.

FIG. 28 is an overall cross-sectional view of the high-pressure washing device when the locking portion of the adapter is locked according to the fourth embodiment of the invention.

FIG. 29 is an overall cross-sectional view of the high-pressure washing device according to a modification of the first embodiment of the invention.

FIG. 30 is an overall cross-sectional view of the high-pressure washing device according to a modification of the second embodiment of the invention.

FIG. 31 is an overall cross-sectional view of a high-pressure washing device according to a modification of the fourth embodiment of the invention.

FIG. 32 is an overall cross-sectional view of the high-pressure washing device according to a modification of the fourth embodiment of the invention.

FIG. 33 is a cross-sectional view of a high-pressure washing device according to a modification of the fourth embodiment of the invention.

FIG. 34 is a schematic perspective view of a high-pressure washing device according to a modification of the fourth embodiment of the invention.

FIG. 35 is a cross-sectional view of a housing of a high-pressure washing device according to a modification of the second embodiment of the invention.

FIG. 36 is a cross-sectional view of a housing of a high-pressure washing device according to a modification of the second embodiment of the invention.

FIG. 37 is a cross-sectional view of the tank according to the first embodiment of the invention.

FIG. 38 is an overall cross-sectional view a state where the tank shown in FIG. 37 is mounted on the high-pressure washing device according to the first embodiment of the invention.

FIG. 39 is a diagram illustrating main components of the high-pressure washing device.

FIG. 40 is a graph having an ordinate representing an output of a motor and an abscissa representing conversion efficiency from the motor to a pump.

FIG. 41 is a graph having an ordinate representing an output of a battery pack and an abscissa representing conversion efficiency from the battery pack to the motor.

FIG. 42 is a schematic diagram showing an adapter.

### BEST MODE FOR CARRYING OUT THE INVENTION

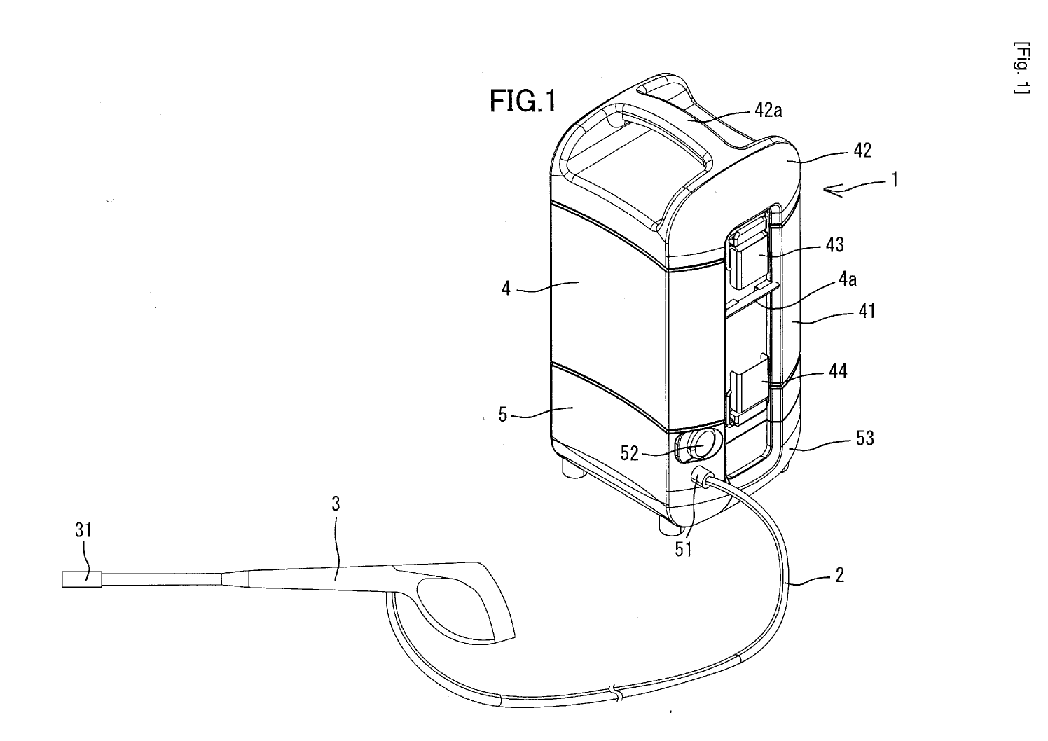

A high-pressure washing device 1 according to a first embodiment of the present invention will be described with reference to FIGS. 1 to 12.

As illustrated in FIG. 1, the high-pressure washing device 1 is connectable to a gun 3 for ejecting cleaning liquid through a high-pressure hose 2. The gun 3 is provided with a switch operated by an operator, and the cleaning liquid is ejected from a nozzle 31 upon the operation of the switch.

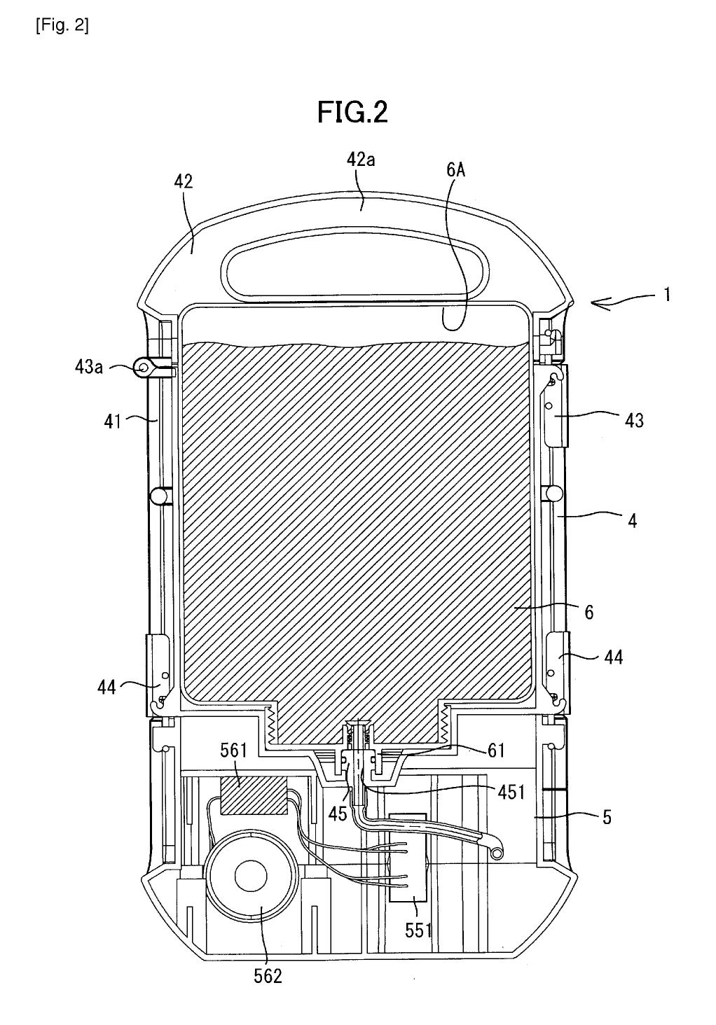

As illustrated in FIGS. 1 and 2, the high-pressure washing device 1 includes an upper housing 4 and a lower housing 5. The upper housing 4 accommodates therein a tank 6 as a container. As described later, the lower housing 5 accommodates a drive section of the high-pressure washing device 1 including a motor 562, a pump 576, and a battery pack 7, so that the lower housing 5 is sometimes hereinafter referred to as drive section. The tank 6 is accommodated in the upper housing 4, which prevents the tank 6 from being subject to direct impact from outside to thereby prevent breakage of the tank 6.

The upper housing 4 includes a main body 41, a lid portion 42, an upper latch 43, a pair of lower latches 44, and a pressing portion 45 serving as a connecting portion to the tank 6. The pressing portion 45 may be provided in the lower housing 5.

That is, in the high-pressure washing device 1 according to the present embodiment, the lid portion 42, the main body 41, and the lower housing 5 (drive section) are aligned downward from above in this order. The tank 6 containing cleaning liquid is accommodated in the main body 41, so that the main body 41 functions as a tank accommodating portion. With this configuration, even if the high-pressure washing device 1 is overturned or dropped, the tank 6 is protected by the tank accommodating portion 41, preventing breakage of the tank 6. Further, even if the connecting portion (pressing portion 45, etc., to be described later, serving as a water-feed inlet from the tank 6) between the tank 6 and drive section is broken due to the overturn, the cleaning liquid can be prevented from leaking outside the tank accommodating portion 41, which in turn prevents the cleaning liquid from being introduced into the drive section. Further, the high-pressure washing device 1 can be used with the tank 6 accommodated therein, eliminating the need to supply the cleaning liquid from waterworks using a water hose. Thus, the high-pressure washing device 1 can be used without limiting a location, allowing use over a wide area.

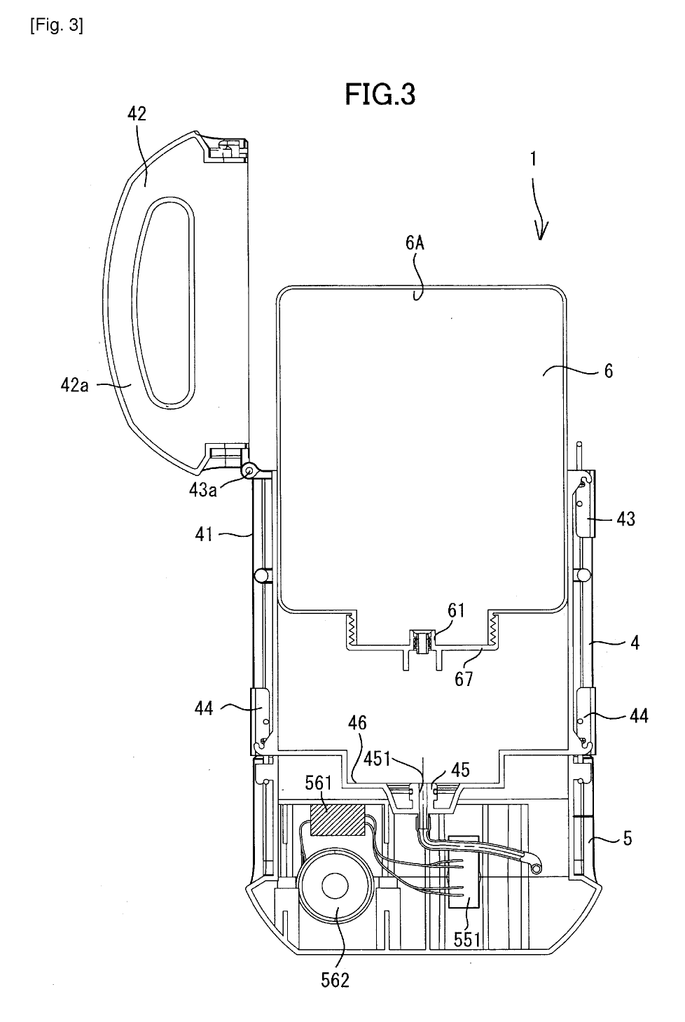

The lid portion 42 can be opened and closed by releasing the upper latch 43, and opening the lid portion 42 about a support shaft 43a as illustrated in FIG. 3 allows the tank 6 to be attached to and detached from the main body 41. Further, releasing the pair of lower latches 44 allows the upper housing 4 and lower housing 5 to be separated from each other. The lid portion 42 is provided integrally with a handle 42 for the operator to grip. The handle 42 corresponds to a handle portion of the present invention.

That is, the lid portion 42 is connected to the tank accommodating portion 41 so as to be openable and closable, so that when an opening portion of the tank accommodating portion 41 is closed by the lid portion 42, the high-pressure washing device 1 can easily be carried by hand by means of the handle 42a, and when the lid portion 42 is opened, the tank 6 can be taken out from the tank accommodating portion 41. Further, when the lid portion 42 is closed in a state where the tank 6 has been taken out, foreign matters can be prevented from entering the tank accommodating portion 41 to thereby prevent the inlet for the cleaning liquid from being clogged. Further, in a case where a water hose is connected, a hose connecting portion where the water hose is connected is protected by the tank accommodating portion 41, preventing the connection from being released by an external force.

Further, the upper housing 4 (tank accommodating portion 41) and lower housing 5 (drive section) can be attached to and detached from each other. When the lower housing 5 is separated from the upper housing 4, the lower housing 5 can be connected to another tank larger than the tank 6 accommodated in the tank accommodating portion 41. That is, tanks of various sizes can be used depending on intended use.

As illustrated in FIGS. 2 and 3, the pressing portion 45 extends in a vertical direction and formed with an inlet 451 extending in the vertical direction. Further, an O-ring 45c serving as a second seal member is installed around an outer periphery of the pressing portion 45. The O-ring 45c may be installed around an inner periphery of a fitting portion 65 described later, not around the outer periphery of the pressing portion 45.

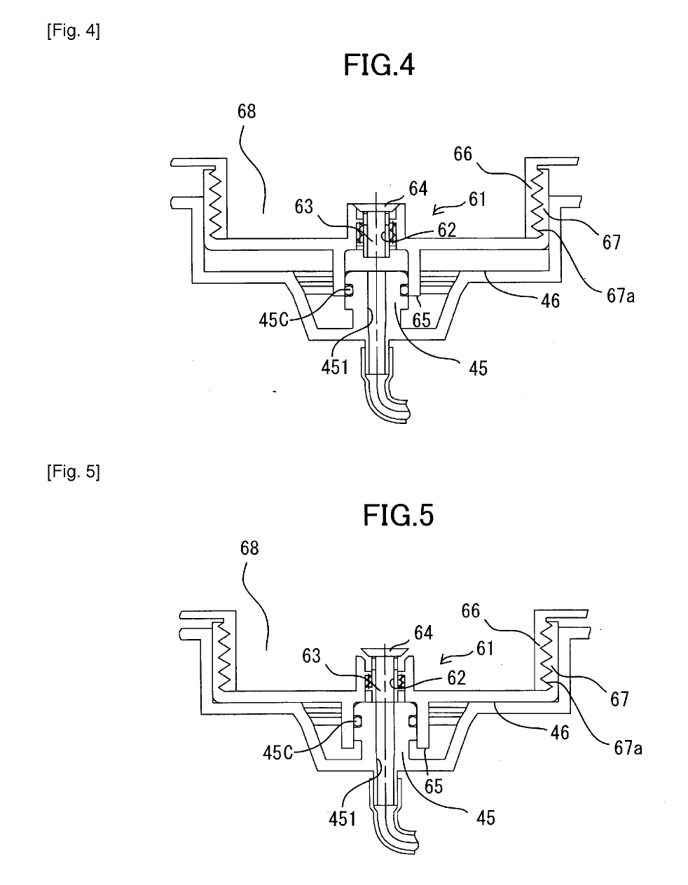

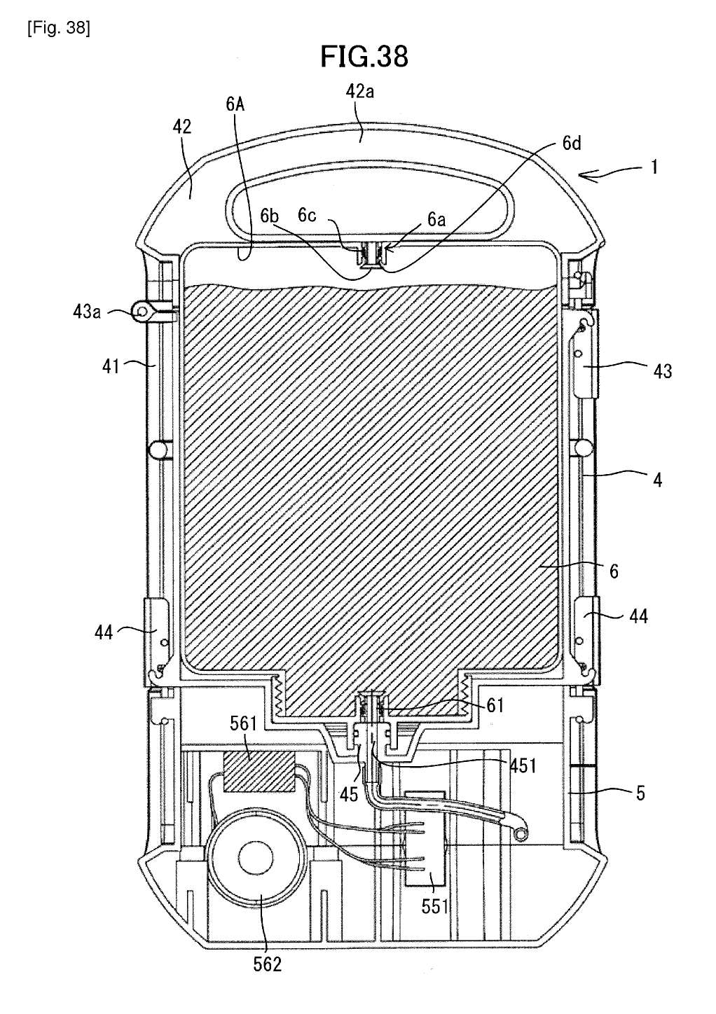

As shown in FIGS. 4 and 5, the tank 6 is formed with an opening portion 68, and is provided with an adapter (lid) 67 covering the opening portion 68. The adapter 67 is meshingly engaged with a screw portion 66 formed around an outer periphery of the opening portion 68 to close the opening portion 68. The tank 6 defines a bottom surface 6A on one side (upper side, in FIG. 2) thereof vertically opposite to another side at which the opening portion 68 is formed. The bottom surface 6A of the tank 6 is provided with an intake valve 6a (FIG. 38). A detailed configuration of the intake valve 6a will be described later. The tank 6 contains cleaning liquid. The adapter 67 of the tank 6 is provided with a connecting portion 61, as illustrated in FIGS. 2 to 5. The connecting portion 61 is formed with an outflow port 62 and provided with a pressed portion 63, a check valve 64 serving as a valve body, and a fitting portion 65. The adapter 67 (screwed portion 67a) is removed from the tank 6 (screw portion 66) in order to pure the cleaning liquid into the tank 6, and tap water is poured into the tank 6 with the opening portion 68 oriented upward. The connecting portion 61 corresponds to a container-side engagement portion and a device-side engagement portion. More specifically, the fitting portion 65 corresponds to the device-side engagement portion, and the screwed portion 67a corresponds to the tank-side engagement portion. The pressed portion 63 and the check valve 64 corresponds to a valve portion of the present invention.

The outflow port 62 extends in the vertical direction, and the pressed portion 63 is disposed in the outflow port 62 so as to be movable in the vertical direction by being spring-biased downward. The check valve 64 is provided at an upper end of the pressed portion 63 so as to be able to close the outflow port 62. The fitting portion 65 has a tubular shape and is coaxially disposed with the outflow port 62 at a portion below the outflow port 62. As illustrated in FIGS. 3 and 4, in a state where the tank 6 is not attached to the upper housing 4, the outflow port 62 is closed by the check valve 64. This prevents the cleaning liquid in the tank 6 from leaking from the outflow port 62.

When attaching the tank 6 to the upper housing 4, as illustrated in FIG. 4, the adapter 67 is fitted into a receiving portion 46 provided inside the main body 41 and having substantially the same shape as that of the adapter 67 of the tank 6, and the pressing portion 45 is fittingly inserted into the fitting portion 65. Then, as illustrated in FIG. 5, the pressed portion 63 is pressed upward by the pressing portion 45 against the spring biasing force, causing the check valve 64 to be pressed upward. As a result, the outflow port 62 is released to allow the cleaning liquid in the tank 6 to flow in the lower housing 5 through the inlet 451. Note that, the O-ring 45c installed around the outer periphery of the pressing portion 45 abuts against the inner peripheral surface of the fitting portion 65, preventing the cleaning liquid from leaking into the upper housing 4.

The outflow port 62 and the inlet 451 are substantially the same in diameter. When the pressed portion 63 and the pressing portion 45 are in contact with each other, the outflow port 62 and inlet 451 are coaxially connected to each other, so that the cleaning liquid from the outflow port 62 flows in the inlet 451 stably. Assuming that a leading end of the outflow port 62 may be made smaller in diameter than a leading end of the inlet 451 so as to be fittingly inserted into the inlet 451, the cleaning liquid can flow in the inlet 451 more reliably.

An outer peripheral surface of the tank 6 and an inner peripheral portion of the main body 41 are substantially the same in dimension. When the tank 6 is attached to the upper housing 4, front-rear and left-right sides (near-far and left-right sides in FIG. 2) of the tank 6 are pressed by an inner wall of the housing 4, allowing the tank 6 to be accommodated stably in the upper housing 4. As to the vertical direction, the adapter 67 of the tank 6 has a lower surface (lower side portion in FIG. 2) in abutment with a bottom surface of the receiving portion 46, and show in FIG. 38 the bottom surface 6A of the tank 6 is in abutment with the lid portion 42, fixing the tank 6 between the receiving portion 46 and lid portion 42. As a result, the tank 6 can be held stably also in the vertical direction. Elastic material may be provided between the tank 6 and inner periphery of the upper housing 4 to absorb impact from outside, thereby preventing breakage of the tank 6 due to external impact.

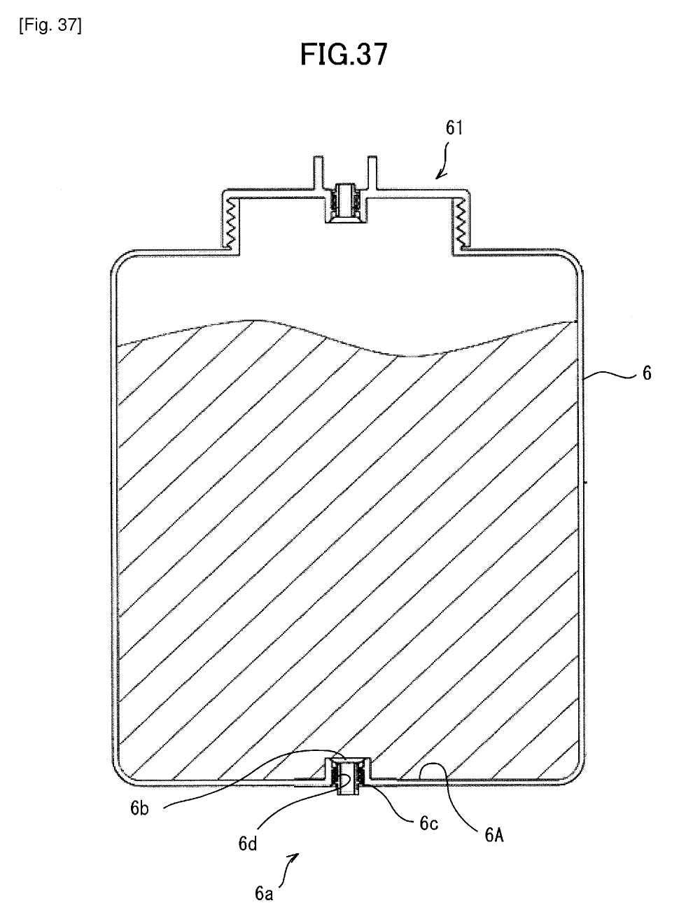

Ejection of the cleaning liquid from the tank 6 during use of the high-pressure washing device 1 causes an inside of the tank 6 to generate a negative pressure. The negative pressure inside the tank 6 may prevent smooth supply of the cleaning liquid to a pump 576 described later or may cause the tank 6 to shrink. In order to avoid this, as illustrated in FIGS. 37 and 38, the intake valve 6a serving as an intake member is provided in the bottom surface 6A of the tank 6. The intake valve 6a serving as an air inlet member is configured of a valve 6b and a spring 6c and closes an air inlet 6d formed on the bottom surface 6A of the tank 6 in an openable manner.

In a state illustrated in FIG. 37 where the tank 6 has been removed from the main body 41, the valve 6b is biased outward (downward in FIG. 37) by the spring 6c to close the air inlet 6d. Thus, although the air inlet 6d (tank bottom surface 6A) is positioned on a lower side when the tank 6 is supplied with water, the cleaning liquid does not leak since the air inlet 6d is closed by the valve 6b.

On the other hand, in a state illustrated in FIG. 38 where the tank 6 has been attached to the main body 41 and the lid 42 is closed, the air inlet 6d is positioned on an upper side. One end (rod portion) of the valve 6b protrudes outward from the bottom surface 6A of the tank 6. When the lid 42 is closed, the lid 42 presses down the rod portion to open the valve 6b against the biasing force of the spring 6c, thereby opening the air inlet 6d. Therefore, air is smoothly taken into the tank 6 via the air inlet 6d, allowing the cleaning liquid to be smoothly supplied to the pump 576. In place of the configuration in which the valve 6b is opened by means of the lid 42, the valve 6b may be configured to automatically open when the cleaning liquid is ejected to decrease a pressure inside the tank 6.

Further, the air inlet 6d and inlet valve 6a need not always be disposed in the bottom surface 6A of the tank 6 but may be disposed in a side surface thereof. In a case where the air inlet 6d and inlet valve 6a are disposed in the side surface of the tank 6, the valve can automatically be opened upon attachment of the tank 6 to the main body 41.

In the present embodiment, the connecting portion 61 to be connected to the pressing portion 45 is provided in the adapter (lid) 67 to be connected to the opening portion 68 of the tank 6, and the inlet valve 6a is provided in a portion (bottom surface 6A) of the tank 6 that is not connected to the adapter 67. However, the connecting portion 61 may be provided in the tank 6, not in the adapter 67, and the inlet valve 6a may be provided in the adapter 67. Further alternatively, the connecting portion 61 may provided in a prescribed surface of the tank 6 and the inlet valve 6a may be provided in different surfaces from the prescribed surface. In this case, since the opening portion 68 needs to be provided, one of the connecting portion 61 and inlet valve 6a is preferably provided in the adapter 67.

As illustrated in FIG. 1, the lower housing 5 is provided with a hose connecting port 51 connected with the high-pressure hose 2, a start switch 52 for starting high-pressure cleaning operation, and an openable/closable battery cover 53. The battery cover 53 is provided with a locking mechanism for maintaining a closed state with respect to the lower housing 5. The start switch 52 is a dial switch, and upon the rotation of the dial, the high-pressure washing device 1 is switched between a stop state and a driven state. Further, an ejection amount of the cleaning liquid may be made to change in accordance with a dial operation amount.

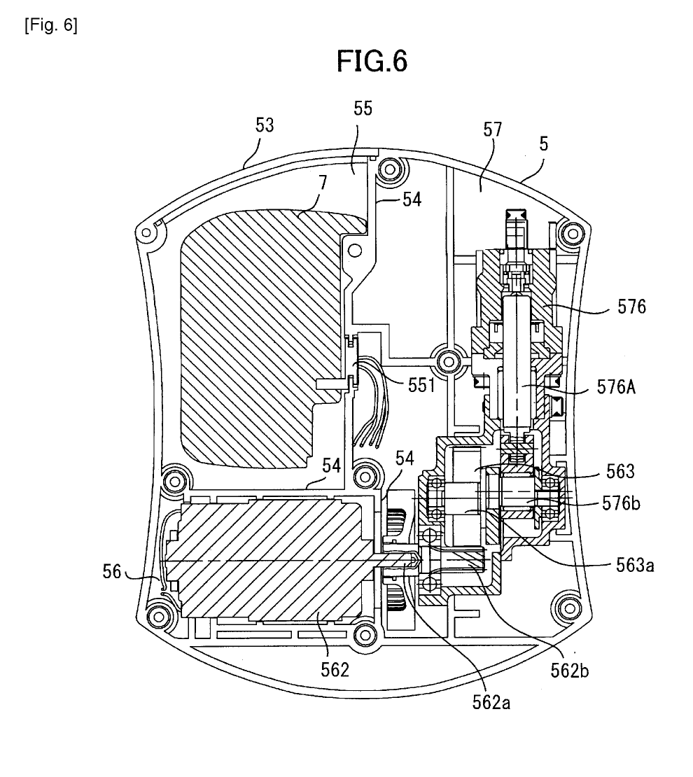

Further, as illustrated in FIG. 6, the lower housing 5 has an inner space divided by a partitioning plate 54 into a battery chamber 55, a motor chamber 56, and a pump chamber 57.

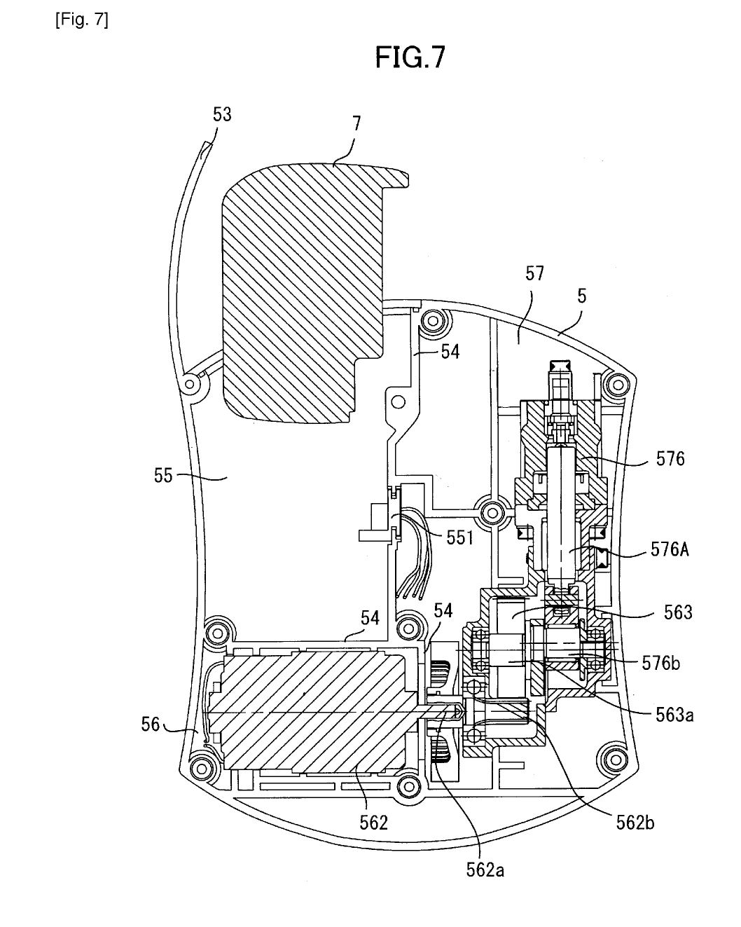

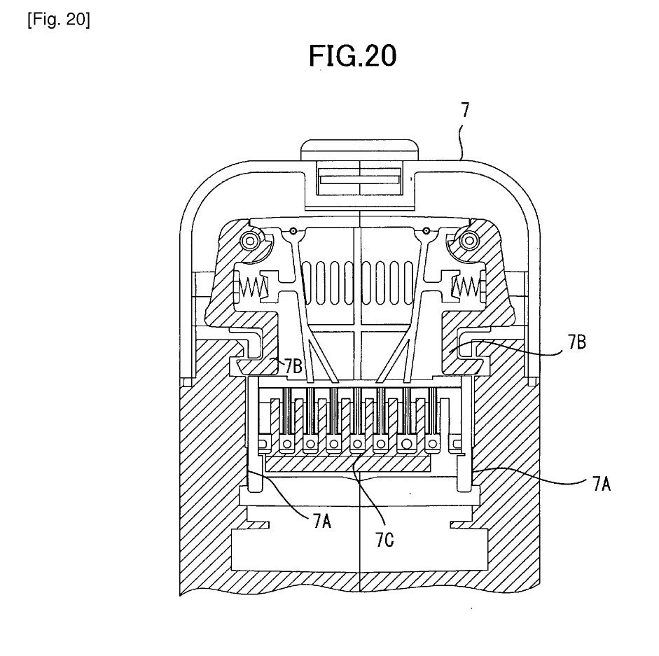

The battery chamber 55 detachably accommodates a battery pack 7 (battery). The battery pack 7 can be attached also to a power tool such as an impact driver and accommodates a rechargeable battery. In the present embodiment, eight lithium ion batteries (4 in series×2 in parallel) each with a rated voltage of 3.6 V and a capacity of 1.5 Ah are accommodated in the battery pack 7, resulting in the battery pack 7 with a rated voltage of 14.4 V and a capacity of 3.0 Ah. As illustrated in FIG. 7, the battery pack 7 can be attached to and detached from the lower housing 5 through the battery cover 53 in an opened state. The battery pack 7 may be attached to the lower housing 5 (battery chamber 55) by using a latching portion 7B (FIG. 20) to be used in attachment to a power tool or by being fitted in the battery cover 53, provided that the battery pack 7 is fixed in the battery chamber 55. A nickel hydride battery or a NiCad battery may be used in place of the lithium battery.

Further, as illustrated in FIGS. 2 and 6, the battery chamber 55 is provided with an electrode 551 (first electrode) abutting against the terminal 7C (second electrode, FIG. 20) of the battery pack 7. The battery pack 7 for the power tool has a pair of rails. The electrode terminal of the battery pack 7 is engaged with the electrode 551 to establish electrical connection therebetween by bringing the pair of rails of the battery pack 7 of a state illustrated in FIG. 7 into engagement with a rail receiving portion provided in the battery chamber 55 and sliding the battery pack 7 in the engaged state along the rail receiving portion, In this state, by bringing a latch portion of the battery pack 7 into engagement with a latch receiving portion of the battery chamber 55, the battery pack 7 can be prevented from being separated from the battery chamber 55.

The motor chamber 56 accommodates therein a control circuit 561 (FIG. 3) and a motor 562. The motor 562 has an output shaft 562a and a spindle 562b connected to the output shaft 562a.

As illustrated in FIG. 2, the control circuit 561 is electrically connected to the electrode 551 in the battery chamber 55 and the motor 562 in the motor chamber 56 and receives supply of power from the battery pack 7 to control the drive of the motor 562. Although not illustrated, the control circuit 561 is electrically connected also to the start switch 52 provided in the lower housing 5. When the control circuit 561 is connected to the start switch 52, i.e., when the start switch 52 is turned ON, the drive control of the motor 562 is started. The start switch 52 is disposed on a current path between the battery pack 7 and the motor 562. When the start switch 52 is turned ON, the current path is closed to start power supply from the battery pack 7 to the motor 562. A switching element may be provided on the current path. In this case, the switching element is controlled in accordance with an amount of operation of the start switch 52, for example, a duty ratio between ON and OFF is switched in accordance with the amount of operation to change rotation of the motor 562 so as to change an ejection amount of the cleaning liquid.

As illustrated in FIG. 2, the motor 562 is electrically connected to the electrode 551 of the battery chamber 55 and is driven by receiving power supply from the battery pack 7. The motor 562 is a DC motor driven by DC power from the battery pack 7. As the DC motor, various motors such as a brush motor and a brushless motor may be used. Further, an AC motor may be used in place of the DC motor. In this case, the control circuit 561 includes an inverter circuit that converts the DC power from the battery pack 7 into AC power.

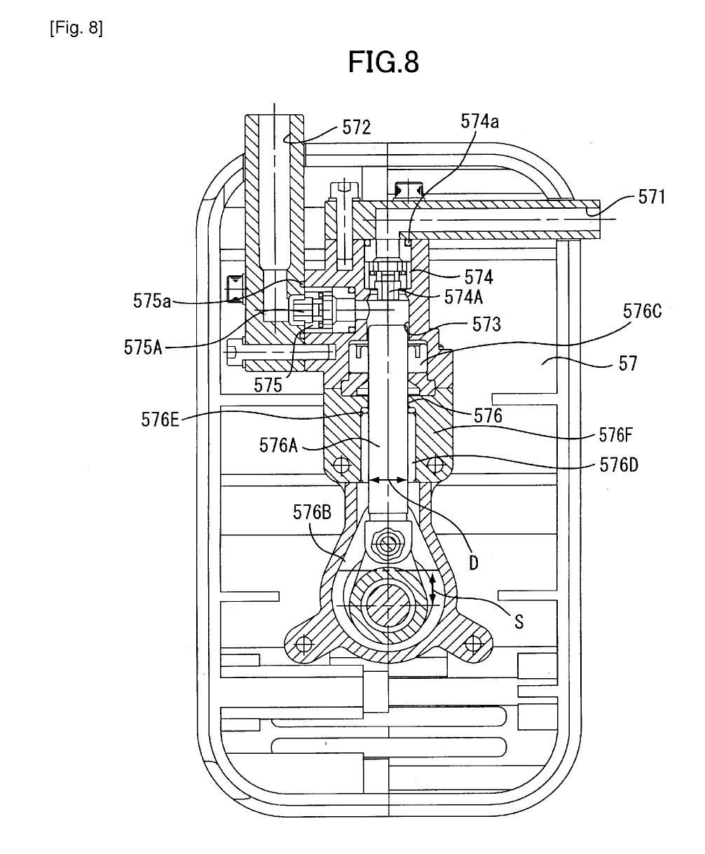

As illustrated in FIG. 8, the pump chamber 57 is provided with an intake port 571 connected to the inlet 451 of the upper housing 4, an ejection port 572 connected to the hose connecting port 51 of the lower housing 5, and a compression chamber 573 disposed between the intake port 571 and ejection port 572. Further, an intake-side valve 574 is disposed between the compression chamber 573 and intake port 571, and an ejection-side valve 575 is disposed between the compression chamber 573 and ejection port 572 in order to prevent the cleaning liquid supplied from the tank 6 from flowing backward from the ejection port 572 to the intake port 571. That is, the intake-side valve 574 and the ejection-side valve 575 functions as a check valve. The compression chamber 573 corresponds to a compression section of the present invention.

The valves 574 and 575 each incorporate a spring and are each closed by the spring biasing force in a normal state. The intake-side valve 574 includes a valve portion 574A. When the valve portion 574A moves downward in FIG. 8, the intake-side valve 574 is open. Similarly, the ejection-side valve 575 includes a valve portion 575A. When the valve portion 575A moves leftward in FIG. 8, the ejection-side valve 575 is open. O-rings 574a and 575a each serving as a seal member are fitted in the valves 574 and 575, respectively, to prevent the cleaning liquid from leaking from the intake port 571 to the compression chamber 573 and from the compression chamber 573 to the ejection port 572.

The pump chamber 57 accommodates a pump 576. The pump 576 is a reciprocating pump, especially, a plunger pump, and more specifically, a single plunger-type pump (provided with one plunger) having a smaller number of plungers than that in a conventional three-plunger type pump. The pump 576 includes a plunger 576A serving as a reciprocating member made of aluminum alloy and a crank 576B. Further, the pump 576 includes a rubber packing 576C, a metal 576D, and a grease leak preventing member 576E. The rubber packing 576C serving as a seal member (first seal member) is brought into contact with an outer periphery of the plunger 576A to prevent the cleaning liquid from leaking from the compression chamber 573 to the crank 576B side. The metal 576D is in sliding contact with the outer periphery of the plunger 576A to improve the sliding ability of the plunger 576A. The grease leak preventing member 576E serving a seal member is brought into contact with the outer periphery of the plunger 576A to prevent grease for lubricating the crank 576B from leaking to the compression chamber 573 side. The plunger 576A is supported by a casing 576F of the pump 576. The casing 576F accommodates the plunger 576A.

Although the plunger pump (driven by the plunger 576A) is used as the pump 576 in the present embodiment, a piston pump may be used in place of the plunger pump. The pump 576 has the seal member 576C on a housing side (on a side of a member that slidably supports the plunger 576A). On the other hand, the piston pump has a seal member (e.g., an O-ring) provided on a piston side (member corresponding to the plunger 576A of the plunger pump) to be driven to prevent leakage of the cleaning liquid (pressure). That is, a pump of any type may be used as the pump 576 as long as the pump can prevent leakage of the cleaning liquid (pressure) and can achieve high-pressure ejection.

The plunger 576A is of substantially a columnar shape and has one end connected to the crank 576B and the other end constituting a part of the compression chamber 573.

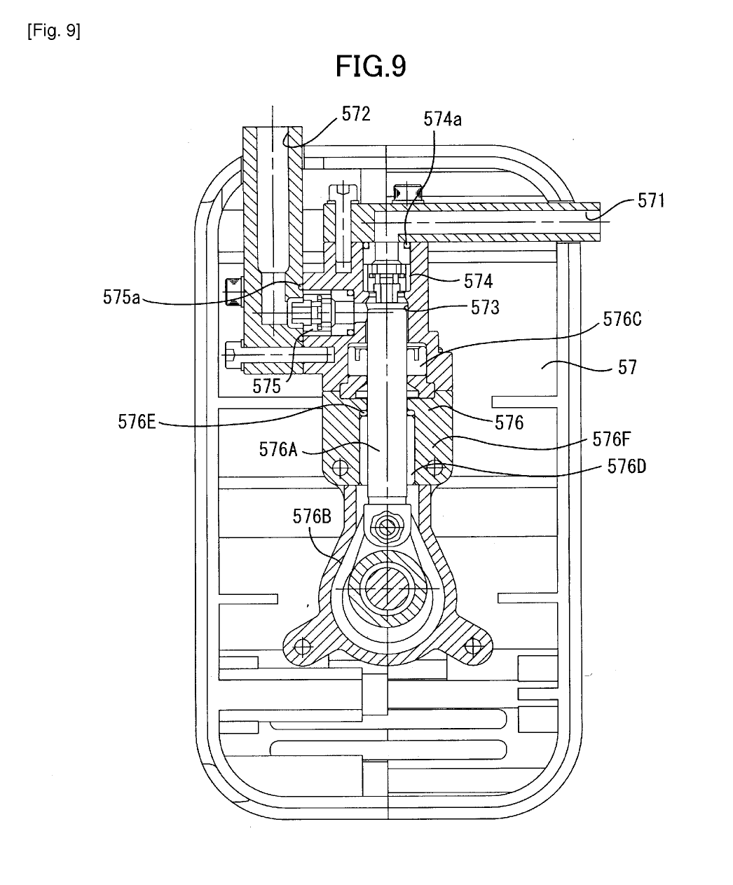

As illustrated in FIGS. 8 and 9, the crank 576B is eccentrically rotated by power from the motor 562, and the plunger 576A reciprocatingly moves in accordance with the rotation of the crank 576B. More specifically, as illustrated in FIG. 8, when the plunger 576A is brought into the lowermost position (bottom dead point), the cleaning liquid flows in the compression chamber 573 through the intake port 571. When the plunger 576A is brought into the topmost position (top dead point) as illustrated in FIG. 9, the cleaning liquid flows out from the compression chamber 573 to the ejection port 572. The cleaning liquid that has flowed in the compression chamber 573 through the intake port 571 is pressurized by the plunger 576A in the compression chamber 573 and ejected through the ejection port 572. A speed reducing mechanism 577 is provided between the motor 562 and the crank 576B.

As illustrated in FIGS. 6 and 7, the speed reducing mechanism is configured of the spindle 562b and gear 563. The gear 563 supported by a gear shaft 563a is engaged with the spindle 562b connected to the motor 562. A rotary shaft 567b of the crank 576B is connected in an eccentric manner to the gear shaft 563a.

The motor 562 and the pump 576 are oriented so as to cross each other. As illustrated in FIGS. 6 and 7, the output shaft 562a extends in a left-right direction toward the pump 576 side in the drawings, and an axis of the pump 576 extends in the vertical direction toward the motor 562 side. That is, the plunger 576A of the pump 576 reciprocatingly moves in the vertical direction in the drawings, and an extension of the reciprocating direction (axial direction) and an extension of the output shaft 562a cross each other at substantially right angles. With this arrangement, a compact configuration can be achieved.

In a case of the conventional three-plunger system, the three plunger system employs a rotating swash plate having a non-uniform thickness in the plunger axial direction to transmit the rotation of the motor, in place of the crank 576B of the embodiment. The rotating swash plate has an inclined surface facing and in contact with the one end portion of the three plungers. Upon rotating the rotating swash plate, the plungers contacting the thickened portion of the rotating swash plate is sequentially pushed whereby the three-plungers are reciprocatingly moved in order. In this configuration, the rotating swash plate needs to be provided in the axial direction of the motor, so that the plunger needs to be provided in parallel to the motor shaft and on an extension thereof. Accordingly, the motor and plunger are disposed so as to face the same direction, resulting in an increase in dimension in the motor shaft direction. Further, since the three plungers are used, a size of the pump becomes relatively large.

On the other hand, according to the present embodiment in which a single plunger 576A is used, the size of the pump 576 can be reduced, and further, the motor 562 and the pump 576 are disposed substantially perpendicularly (in an L-shape) to each other, so that a dimension of the drive section in the motor axial direction can be reduced as compared to the conventional three-plunger system. That is, the output shaft 562a extends in a direction (first direction) perpendicular to an axial direction of the single plunger 576A (second direction). Further, since the battery pack 7 is arranged in a space between the motor 562 and the pump 576, a space (rectangular region) created by the arrangement of the motor and pump can be effectively used, and the drive section can become compact even in a configuration in which the battery pack 7 is provided. Specifically, FIG. 6 shows a cross-sectional view of a plane perpendicular to the top-bottom direction. The rectangular region is substantially rectangular shape having four sides. Each of the output shaft 562a and an axis of plunger 576A comprises one of the four sides. When FIG. 6 is viewed in the left-right direction, the battery pack 7 and the motor 562 overlap the pump 576, i.e., in FIG. 8, the battery pack 7 and motor 562 are disposed on a back side of the pump 576, reducing the dimensions of the drive section in all the directions.

Operation of the pump 576 will concretely be described. In an initial state, i.e., in a state where the plunger 576A is located at the top dead point, the valves 574 and 575 are closed. When the plunger 576A moves to the bottom dead point side, a capacity of the compression chamber 573 increases to bring the inside of the compression chamber 573 into a negative pressure. The intake-side valve 574 is pulled by the negative pressure to be opened, and the ejection-side valve 575 is pulled by the negative pressure to maintain a closed state thereof. When the intake-side valve 574 is opened, the cleaning liquid from the intake port 571 flows in the compression chamber 573 through the intake-side valve 574.

When the plunger 576A further moves to reach the bottom dead point (state of FIG. 8), the compression chamber 573 and the intake port 571 become equal in pressure, so that the intake-side valve 574 is closed to seal up the compression chamber 573. When the plunger 576A moves from the bottom dead point to the top dead point side, the pressure inside the compression chamber 573 increases since both the valves 574 and 575 are closed to seal up the compression chamber 573. As the pressure inside the compression chamber 573 increases, the ejection-side valve 575 is open while the intake-side valve 574 maintains a closed state thereof. As a result, the cleaning liquid in the compression chamber 573 is pushed by the plunger 576A to flow in the ejection port 572 through the ejection-side valve 575. Thus, high-pressure cleaning liquid is ejected from a nozzle 31 to be described later through the high-pressure hose and gun 3.

When the plunger 576A further moves to reach the top dead point (state of FIG. 9), the cleaning liquid in the compression chamber 573 runs out, and the valve portion of the ejection-side valve 575 is not pushed by the cleaning liquid, closing the ejection-side valve 575. As a result, both the valves 574 and 575 are closed, i.e., the pump 576 is returned to the initial state. By repeatedly performing the above operation, high-pressure cleaning liquid can be ejected.

The pressurized cleaning liquid is supplied to the gun 3 through the ejection port 572 and high-pressure hose 2. A distal end of the gun 3 is formed with the nozzle 31 having an extremely small diameter of about 0.6 mm, and thus the cleaning liquid is further pressurized by the nozzle 31 before the ejection thereof. As described above, high-pressure ejection can be achieved since the diameter of the nozzle 31 (diameter of an ejection port of the gun 3) is as extremely small as 0.6 mm. In order to achieve an output of about 7.0 MPa in consideration of the dimension of the compression chamber 573 or plunger 576A and flow rate, 0.6 mm is optimum as the diameter of the nozzle 31. When an amount of the cleaning liquid to be pushed in one reciprocating motion of the plunger 576A is large, the nozzle diameter can be designed more than 0.6 mm. On the other hand, when the amount of the cleaning liquid to be pushed in one reciprocating motion of the plunger 576A is small, the nozzle diameter needs to be reduced from 0.6 mm. That is, the nozzle diameter needs to be designed in consideration of the amount of the cleaning liquid to be pushed in the reciprocating motion of the plunger 576A or the like.

The seal member 576C is provided so as to be in contact with the outer periphery of the plunger 576A, the valves 574 and 575, and the O-rings 574a and 575a fitted in the valves prevent the cleaning liquid in the compression chamber 573 from leaking outside, that is, do not interfere with a pressure rise in the compression chamber 573 associated with the movement of the plunger 576A, with the result that the cleaning liquid (pressure) pushed by the plunger 576A is ejected unchangedly from the nozzle 31, thereby achieving high-pressure (e.g., about 3.0 MPa) cleaning. Note that the pressure of 3.0 MPa has experimentally been calculated as the lowest pressure at which stains are actually washed out with a nozzle diameter of 0.6 mm. However, the lowest pressure is not limited to the above value, but may be appropriately set in accordance with the diameter of the ejection port of the nozzle 31.

The pump system includes not only the plunger system, but also a rotary pump system and the like. In the rotary pump system, when a pressure in the rotary pump is increased, the cleaning liquid is returned (flows back) between a rotating body and a casing thereof to prevent pressure rise. Thus, the rotary pump type is not suitable for high-pressure cleaning but for an atomizer (operating at a pressure of about 0.5 MPa) that does not require high-pressure.

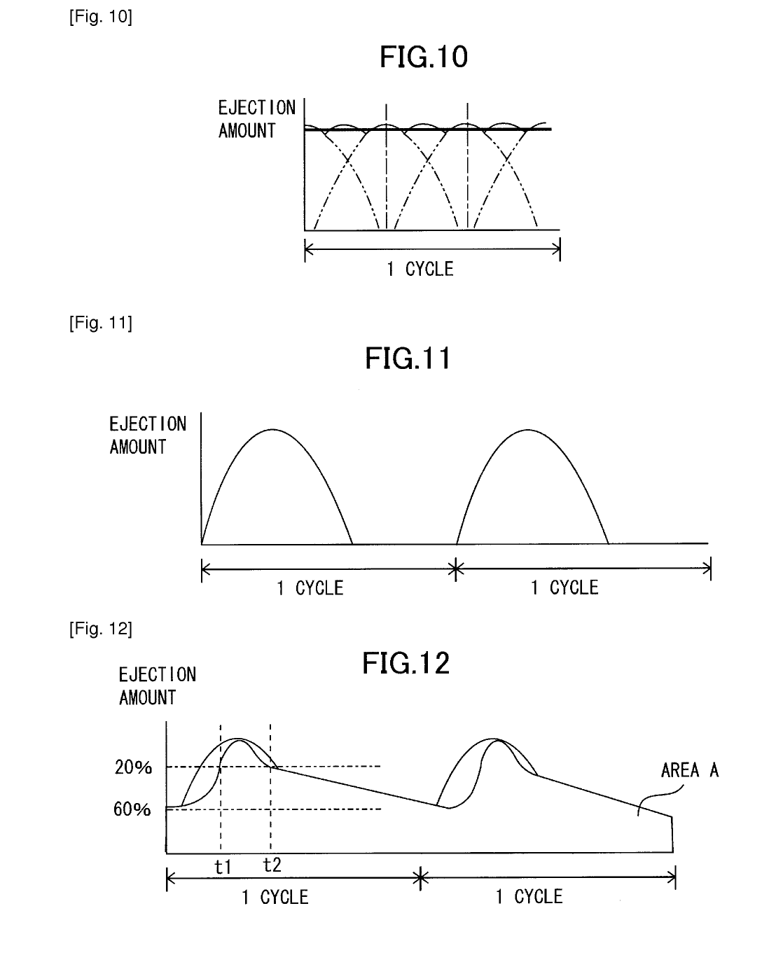

Conventional common type high-pressure washing devices adopt the three-plunger system (provided with three plungers). In the three-plunger system, three plungers are made to reciprocate with a phase difference of 120 degree with each other to eject the cleaning liquid. Thus, as illustrated in solid line of FIG. 10, the cleaning liquid is ejected with substantially no pulsation (theoretically, there is a flow variation of 13%). Although, the three-plunger system is capable of performing continuous high-pressure ejection, the cleaning liquid is wasted due to continuous ejection thereof. In a case where a gear pump is used in place of the plunger pump, the cleaning liquid can be continuously ejected always in a fixed amount. However, the high-pressure (e.g., 3.0 MPa or more) ejection cannot be performed unlike the case of using the plunger pump.

The high-pressure washing device 1 according to the present embodiment, adopting the single plunger system as described above, can resolve the above drawback of the three-plunger system. Theoretically, in the single plunger system, the cleaning liquid ejected from the nozzle 31 during one reciprocating motion of the plunger 576A (one rotation of the crank 576B) varies in amount so as to have 100% pulsation (variation in flow rate), as illustrated in FIG. 11. Thus, the high-pressure washing device 1 can reduce the amount of the cleaning liquid to be used in a certain time to one-third of that in the three-plunger system, thus suppressing the waste of the cleaning liquid while maintaining the ejection amount (high-pressure ejection).

In the present embodiment, the high-pressure cleaning is performed using the cleaning liquid accommodated in the tank 6, that is, there is a limit to the amount of cleaning liquid to be used. On the other hand, most conventional high-pressure washing device is used by connecting to the waterworks, that is, the cleaning liquid is supplied substantially unlimitedly. Thus, in the case where the cleaning liquid is supplied from the waterworks as in the conventional way, the use of the three-plunger system is not problematic. However, in the case where there is a limit to the amount of the cleaning liquid to be used as in the present embodiment, there occurs a problem that the cleaning liquid in the tank 6 is used up early. Therefore, in the tank system where there is a limit to the amount of the cleaning liquid to be used, the single plunger system capable of performing high-pressure ejection equivalent to that in the three-plunger system and suppressing the waste of the cleaning liquid is more suitably used. The use of such a single plunger system can prolong operation time.

Further, the single plunger system, having only one plunger 576A, can reduce a sliding resistance caused by the reciprocating motion to about one-third of that in the three-plunger system. On the other hand, the three-plunger system drives the three plungers, casing a large sliding resistance between the plungers and a member supporting the plungers, resulting in an increase in power consumption. The single-plunger system is, as described above, capable of reducing the sliding resistance to about one-third due to existence of only one plunger, thus suppressing the waste of power. Thus, the high-pressure washing device 1 according to the present embodiment can increase efficiency of the reciprocating motion of the plunger 576A, i.e., rotating efficiency of the motor 562, which in turn results in suppression of electric power of the battery pack 7.

In the present embodiment, the motor 562 is driven by power supplied from the battery pack 7, that is, there is a limit to the amount of power to be used. On the other hand, conventional high-pressure washing devices receive power supply from a commercial power supply, that is, the power is supplied substantially unlimitedly. Thus, if the power is supplied from the commercial power supply as in the conventional way, the use of the three-plunger system not effective in power saving is not problematic. However, if there is a limit to the amount of the power to be used as in the present embodiment, the power of the battery pack 7 may be used up immediately to fail to drive the motor 562. Therefore, in a cordless type (battery-driven type) having a limit to the amount of the power to be used, the single plunger system is more appropriately used because of increasing the rotating efficiency of the motor 562 to suppress the waste of the power of the battery pack 7 while performing high-pressure ejection equivalent to that in the three-plunger system. The use of such a single plunger system can prolong operation time.

Further, in the three-plunger system, a motor having a high rated output is required in order to overcome the sliding resistance of the three plungers, disadvantageously increasing a size of the entire device, which results in an increase in weight thereof. On the other hand, in the single plunger system, the sliding resistance can be suppressed since only one plunger is provided, so that a small-sized motor suffices. Further, the number of parts can be reduced to thereby reduce the size and weight of the entire device. Thus, adoption of the single plunger system allows the use of a cordless type (connection to the commercial power supply is not required) high-pressure washing device 1 that is driven by the small-sized and light-weighted battery pack 7. Thus, there can be provided a user-friendly high-pressure washing device 1 capable of being carried/operated by hand and thus not restricted in terms of working area.

Actually, the ejection port 572 (compression chamber 573) is subject to a pressure that prevents ejection of the cleaning liquid from the high-pressure hose 2 side. That is, the nozzle 31 has a diameter of as small as 0.6 mm, so that the cleaning liquid is difficult to eject. When a pressure in the ejection port 572 is increased, the high-pressure hose 2 is expanded to function in the same manner as the compression chamber 573 to suppress pulsation, so that 100% pulsation (variation in flow rate) as illustrated in FIG. 11 cannot be achieved.

In an extreme case, the pulsation of the cleaning liquid ejected from the nozzle 31 approaches to substantially 0% (pulsation becomes small) in a case where the plunger 576A is made to reciprocate at high-speed and approaches to substantially 100% (pulsation becomes large) in a case where the plunger 576A is made to reciprocate at low-speed. However, in reciprocating motion of the plunger 576A at extremely high-speed, the cleaning liquid and electric power are wasted as in the case of the three-plunger system, whereas in the reciprocating motion at extremely low-speed, cleaning capability may become insufficient, and vibration due to the pulsation may be increased.

In order to cope with this, in the high-pressure washing device 1 according to the present embodiment, the reciprocating motion (the number of reciprocations) of the plunger 576A, that is, a rotating speed of the motor 562 is controlled such that the pulsation of the cleaning liquid ejected from the nozzle 31 becomes 20% or more, preferably, in a range of 20% to 60% as illustrated in FIG. 12, i.e., the pressure of the cleaning liquid ejected from the nozzle 31 has a variation rate more than or equal to 20% and less than or equal to 60%. The variation rate is defined by dividing a range of pulsation by the maximum value of the pressure. For example, assuming that the maximum value of the pressure is at 3.0 Mpa, the minimum value of the pressure is at 2.4 Mpa. The pressure of the cleaning liquid is pulsated between the 3.0 Mpa and 2.4 Mpa. In this case, the variation rate is calculated by dividing 0.6 Mpa (3.0 Mpa minus 2.4 Mpa) by 3.0 Mpa to get 20%. More specifically, the control circuit 561 controls the motor 562 such that the plunger 576A reciprocates at a speed range of 1,000 rpm to 5,000 rpm.

As a result, the cleaning liquid can be ejected from the nozzle 31 at a pressure having sufficient cleaning capability while suppressing the waste of the cleaning liquid. In the present embodiment, the cleaning liquid is configured to be ejected at a pressure of about 3.0 MPa to 7.0 MPa from the nozzle 31 by recprocatingly moving the plunger 576A at a speed range of 1,000 rpm to 5,000 rpm. The term high-pressure used in the present embodiment refers to a pressure higher than that (e.g., 0.3 MPa) of common waterworks (specifically, 3.0 MPa or more, in the present embodiment).

In the pump 576 of the single plunger system, setting of a diameter D, a stroke S, and the reciprocation number N (rotating speed of the motor) of the plunger 576A for obtaining an ejection pressure of 3.0 MPa with a nozzle diameter of 0.6 mm will be described in detail. Performance of the pump 576 depends upon the diameter D, the stroke S, and the reciprocation number N of the plunger 576A, and a flow rate V of water ejected in one minute is represented by the following equation 1.

V(L/min)=D(mm)×S(mm)×N(rpm)×a (equation 1)

In equation 1, the diameter D is a diameter of the plunger 576A of FIG. 8 in a radial direction thereof, the stroke S is a distance between both the dead points of the plunger 576A, a is a return coefficient at valve opening/closing time, which is a constant value. Assuming that the number of reciprocations of the plunger 576A is constant value N (rpm), i.e., the rotating speed of the motor 562 is constant. In this case, in order to realize a predetermined flow rate V (liter/minute), the diameter D and the stroke S need to be controlled. More specifically, the diameter D is increased while the stroke S is reduced, or the diameter D is reduced while the stroke S is increased.

When the diameter D is increased, an area where the plunger 576A pushes the cleaning liquid is correspondingly increased. For example, if the cleaning liquid is ejected at 3.0 MPa by the plunger 576A having 10 mm diameter D, a thrust force of 236 kg is required generally calculated by radius×radius×p×pressure. If the diameter D is increased by 2 mm, a thrust force of 339 kg is required. That is, an increase of only 2 mm in the diameter D requires an increase in a thrust force by 103 kg. In order to increase the thrust force, the motor 562 needs to be replaced with a higher-output (larger) motor and, further, a bearing and a housing each subjected to reaction force need to be reinforced. This leads to an increase in the size of the entire high-pressure washing device 1 and cost.

On the other hand, when the stroke S is increased, a travel amount of the plunger 576A is correspondingly increased. For example, if the stroke S is 5 mm, a clearance of the compression chamber 573 corresponding to a radius of 2.5 mm of the crank 576B and a 5 mm stroke is required. In order to further increase the stroke S by 5 mm, a clearance of the compression chamber 573 corresponding to a radius of 5 mm of the crank 576B and a 10 mm stroke is required. That is, an increase of 5 mm in the stroke requires an extended structure of 7.5 mm in total, leading to an increase in the size of the entire high-pressure washing device 1.

Further, in a case where the reciprocation number N of the plunger 576A is constant, Dt seconds which is time required for one stroke is constant. Thus, an average plunger speed U is calculated by the following equation 2.

U(m/s)=N(rpm)/60×S(m)×2 (equation 2)

If the reciprocation number N of the plunger 576A is set to a constant value of 3,000 rpm, the speed U is 0.5 m/s when the stroke S is 5 mm and, when the stroke S is increased to 10 mm, the speed U is doubled (1.0 m/s). The plunger 576A reciprocatingly moves while slidingly contacting the seal member 576C and the metal 576D. When the stroke S is increased to increase the speed U, a material having higher abrasion resistance is necessary, leading to an increase in cost.

Next, a case is considered where the reciprocation number N (rotating speed of the motor 562) of the plunger 576A is variable. If the reciprocation number N is set to a given value, the reciprocation number N and a displacement volume J need to be adjusted in order to realize a predetermined flow rate V. The displacement volume J is defined by multiplying a cross-section area of the plunger 576A by the stroke S.

An increase in the reciprocation number N allows a reduction of the displacement volume J while maintaining the predetermined flow rate V, thereby allowing a reduction in a size of the plunger 576A. The high-pressure hose 2 extends from the plunger 576A to the nozzle 31, and the expansion/contraction of the high-pressure hose 2 suppresses the pulsation. That is, when the cleaning liquid is ejected at high-speed with a small volume, ejection pulsation becomes smaller than a theoretical ejection waveform (FIG. 11) of the single plunger system, resulting in a reduction of flow rate restricting effect.

On the other hand, if the reciprocation number N is reduced while maintaining the predetermined flow rate V, the displacement volume J is correspondingly increased and the size of the plunger 576A is also increased. In this case, the ejection pulsation is relatively larger so as to become generally the theoretical ejection waveform (FIG. 11) of the single plunger system, which enhances the flow rate restricting effect. However, the extremely small reciprocation number N is not preferable because the pulsation may cause vibration.

Thus, the diameter D, the stroke S, and the reciprocation number N of the plunger 576A each need to be set to an optimum value in consideration of the size of the device, cost, flow rate, or the like. In the present embodiment, the optimum range of use of each setting values is experimentally calculated in terms of suppressing an increase in the size of the device and cost, the use amount of electric power and water, and the vibration. Specifically, in the present embodiment, the plunger diameter D is set to 5 mm to 20 mm, the stroke S is set to 3 mm to 10 mm, and the reciprocation number N of the plunger 576A is set to 1,000 rpm to 5,000 rpm. More specifically, in the present embodiment, in order to obtain an ejection pressure of up to about 7.0 MPa with the nozzle diameter of 0.6 mm, the plunger diameter D is set to 12 mm, the stroke S is set to 5 mm (eccentricity of the crank 576B is 2.5 mm), and the reciprocation number N of the plunger is set to 3,000 rpm, as optimum values.

In the single plunger system, the ejection pulsation reaches 100% as illustrated in FIG. 11 in a theoretical manner. However, actually the expansion/contraction of the high-pressure hose 2 functions as an accumulator. Thus, the flow rate (pulsation) does not reach zero, and the pulsation falls within a range of 20% to 60% as illustrated in FIG. 12. When, at least, the ejection pulsation falls within a range of 20% to 60%, the amount of water to be used can be suppressed as compared to the conventional three-plunger system. That is, assuming that the ejection pressure is up to 3.0 MPa, a minimum value of the ejection pressure falls within 1.2 MPa to 2.4 MPa, which is obtained by multiplying the maximum ejection pressure (3.0 MPa) by the pulsation range of 20% to 60% (0.6 MPa to 1.8 MPa), thereby suppressing the consumption of water (suppression of waste of the cleaning liquid).

A peak time during which the cleaning liquid is ejected at the maximum pressure is a certain time period (momentary) within one reciprocating motion of the plunger 576A. In other word, a time period during which the cleaning liquid is ejected at a pressure other than the maximum pressure is extremely longer than the peak time. As illustrated in FIG. 12, a region from t1 to t2 in one reciprocating motion of the plunger 576A represents a region in which the pulsation is 20% or less (high-pressure ejection), and in a region other than the range from t2 to t2, the pulsation is 20% or more. Thus, a maximum pressure region is defined as a range in which the pulsation is 20% or more in one reciprocating motion (one-cycle). A remaining pressure region is defined as a range in which the pulsation is less than 20% in one-cycle. The maximum pressure region indicates a total amount of the cleaning liquid ejected from the nozzle 31 from t1 to t2. The remaining pressure region indicates a total amount of the cleaning liquid ejected from the nozzle 31 during a time period other than t1 to t2 in one reciprocating motion. The remaining pressure region is more than or equal to three times as large as the maximum pressure region. That is, a corresponding time period of the maximum pressure region is about a quarter of one reciprocating motion (one-cycle), so that the amount of water (waste of the cleaning liquid) to be used can be suppressed.

Thus, in the single plunger system, the ejection pressure is raised to a peak value equivalent to that in the conventional three-plunger system for each stroke of the plunger 576A, thereby allowing achievement of the high-pressure cleaning. At this time, the ejection pressure (water amount) pulsates, so that the cleaning can be performed while saving the amount of the cleaning liquid to be used as compared to the continuous ejection in the conventional three plunger system. FIG. 12 shows an area A representing a total amount of the water to be actually used, that is, an amount of work of the pump 576, which is about half (theoretically, one-third of) the work amount in the conventional three-plunger system illustrated in FIG. 10. Thus, high-pressure cleaning equivalent to that performed in the conventional device can be performed while saving the waste of power consumption of the battery pack 7 and cleaning liquid.

Further, the conventional three-plunger system employs the rotating swash plate having a non-uniform thickness in the plunger axial direction instead of the crank 576B. In detail, the inclined surface of the rotating swash plate is in confrontation with the three plungers. That is, the rotation of the rotating swash plate in this state causes the plungers contacting the thickened portion of the rotating swash plate to sequentially be pushed, whereby the plungers can be made to reciprocate.

However, in such a configuration, the rotating swash plate and the plunger are in sliding contact with each other, and the sliding resistance therebetween consumes more electric power.

On the other hand, in the present embodiment, the plunger 576A is made to reciprocate by means of the crank 576B, reducing the sliding resistance (there is no sliding resistance between the rotating swash plate and plunger) as compared to the three-plunger system. Also in this regard, the power consumption can be saved. Although the single plunger system is adopted in the present embodiment, a two-plunger system in which the number of the plungers to be provided is smaller than in the three-plunger system may be adopted, provided that the ejection pressure equivalent to that in the three-plunger system can be obtained while suppressing the amount of water to be ejected. In the case of the two-plunger system, two plungers are made to reciprocate with a phase difference of 180 degree. Thus, the cleaning liquid is not always ejected, so that the two-plunger system is more effective in water-saving and power-saving than the three-plunger system, although less effective than the single plunger system.

The following describes selection of a capacity of the battery pack 7 by which the high-pressure ejection can be achieved in the cordless type high-pressure washing device 1 of the present embodiment which is provided with the tank 6 and driven by the battery pack 7.

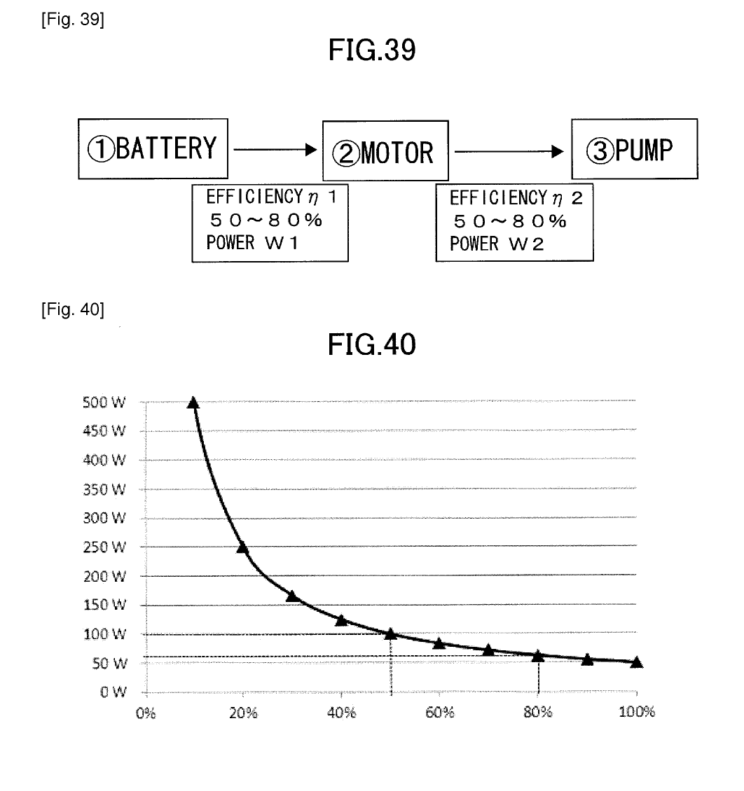

As illustrated in FIG. 39, the high-pressure washing device 1 mainly includes the battery pack 7, the motor 562, and the pump 576. There is a limit to power supply from the battery pack 7, and power consumption thereof depends upon efficiencies of the motor 562 and the pump 576.

Conversion efficiency is considered among the battery pack 7, the motor 562, and the pump 576. As illustrated in FIG. 39, there exist a first efficiency (h1) of converting power of the battery pack 7 into rotary motion of the motor 562 and a second efficiency (h2) of converting the rotary motion of the motor 562 into the reciprocating motion (cleaning liquid compression motion) of the pump 576 (plunger 576A). The above conversion efficiencies are ideally 100% but does not actually reach 100% due to copper loss, iron loss, and mechanical loss for the first efficiency (h1) and due to mechanical loss and piping loss for the second efficiency (h2). That is, selecting the battery pack 7 and the motor 562 appropriate for the respective efficiencies (h1, h2) allows achievement of the cordless type (battery-driven) washing device 1 capable of performing high-pressure ejection.

First, a motor output required to drive the pump 576 based on the second efficiency (h2) will be discussed. Assuming that P stands for an ejection pressure and Q stands for an ejection flow rate, a power W2 (motor output, second power) required to drive the pump 576 can be generally calculated by the following equation 3.

W2(W)=P(MPa)×Q(L/min)×1,000/60/h2 (equation 3)

FIG. 40 is a graph in which a regular ejection pressure P is set to 3.0 MPa (minimum pressure of a common type household high-pressure washing device) and a regular ejection flow rate Q is set to 1 liter per minute. The graph has the abscissa representing the second efficiency h2 and the ordinate representing the power W2.

Assuming that the second efficiency h2 is 50% to 80% which is a pump efficiency of the common type high-pressure washing device, the power W2 of about 60 W to 100 W is obtained from FIG. 40 (dotted line). Thus, the power W2 (motor output) required to drive the pump 576 is about 60 W to 100 W.

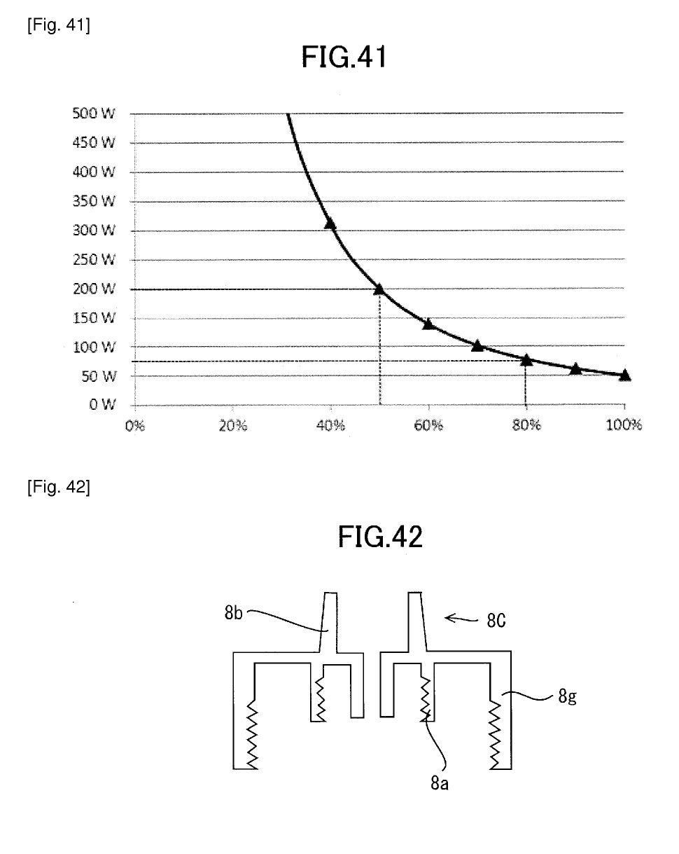

The motor 562 is driven by power supplied from the battery pack 7. Here, battery pack power W1 (first power) will be considered in order to attain about 60 W to 100 W as the power W2 (motor output). The power W2 is a value obtained by multiplying the battery pack power W1 by the first efficiency h1 and, accordingly, the battery pack power W1 can be obtained by dividing the power W2 by the first efficiency h1 and represented as shown in a graph of FIG. 41. In FIG. 41, the abscissa represents the first efficiency h1 and the ordinate represents the battery pack power W1.

Assume here that the motor 562 is a commonly-used DC motor. In this case, motor efficiency of the motor 562 is 50% to 80%. As show in the graph of FIG. 41, if the first efficiency h1 is 50% to 80%, the battery pack power W1 is about 75 W to 200 W as indicated by dotted line. Thus, the most inefficient combination of the power W2 and the battery pack power W1 requires 200 W as the battery pack 7. Even if the efficiency h1 is 50% which is the most inefficient combination, the high-pressure washing device 1 can be operated stably because the battery pack 7 has substantially 200 W power. Preferably, in order to obtain stable cleaning operation, the power of the battery pack 7 may be more than or equal to 200 W. In a case where a brushless motor is used as the motor 562, motor efficiency is improved. In this case, there is no problem if the power of the battery pack 7 is 200 W or less. A minimum power of the battery pack 7 can appropriately be set depending on a type of the motor to be used.

The battery pack 7 will next be described in detail. According to the above description, the power of the battery pack 7 is required at 200 W. Assuming that the tank 6 can accommodate the cleaning liquid of 4 liters. It is preferable that the battery pack 7 is required to supply enough power for the cleaning liquid of 4 liters to be ejected completely in one cleaning operation (one charging of the battery pack 7). Thus, assuming that the ejection flow rate Q of the nozzle 31 is 1 liter per minute, the battery pack 7 is required to have a capacity of about 13.3 Wh (200 (W)×4 (Liters)/1=800 (W/min)).

To obtain an output power of 200 W from the battery pack 7 (a lithium ion battery) whose battery cell has 3.6 V rated voltage and 20 A discharge current, at least three battery cells are required (3.6 V×3 (series or parallel connected cells)×20 A=216 W). That is, when the three cells are connected in series, the battery pack 7 of 10.8 V or more can be applied. Three or more cells are connected in parallel, an output power equal to or greater than that of the battery pack of 10.8 V can be obtained. Examples of a rated voltage of the battery pack 7 used in a power tool include 3.6 V, 10.8 V, 14.4 V, 18.0 V, 25.2 V, and 36.0 V, and examples of a battery capacity thereof include 1.5 Ah, 2.0 Ah, and 3.0 Ah. The battery voltage and battery capacity differs depending on the number of series-connected battery cells and the number of parallel-connected battery cells, respectively. For example, when three 3.6 V battery cells are connected in series, 10.8 V is obtained as the battery pack, and when two 1.5 Ah battery cells are connected in parallel, 3.0 Ah is obtained as the battery pack. The voltage and the capacity per battery cell differ depending on manufacturers. Although, the present embodiment employs a battery pack having a rated voltage of 3.6 V and a capacity of 1.5 Ah, various types of battery cells is available.

The battery pack 7 having a rated voltage of 10.8 V and a capacity of 1.5 Ah achieves a capacity of 16.2 Wh. A battery pack having a rated voltage of 10.8 V or more satisfies the required capacity of 13.3 Wh. Alternatively, a battery in which three battery cells each having a rated voltage of 3.6 V are connected in parallel can satisfy the required capacity.

Next, cleaning operation time of the high-pressure washing device 1 will be considered. For example, in a case where the battery pack 7 has a rated voltage of 10.8 V and a capacity of 1.5 Ah, a battery energy of 16.2 Wh is obtained. Assuming that a minimum power of the battery pack 7 is 200 W, cleaning operation can be performed for about five minutes. The cleaning liquid (4 liters) in the tank 6 can be consumed within this five minutes. That is, cleaning operation time can be ensured during which at least the cleaning liquid (4 liters) in the dedicated tank 6 of the high pressure washing device 1 can be consumed.

From above, a relationship among the rated voltage (V), the battery capacity (Ah), the battery energy (Wh), and the cleaning operation time (minute) is obtained as shown in Table 1 below. At this time, the ejection pressure is set to 3.0 MPa, the ejection flow rate Q is to 1 liter per minute, the battery power is to 200 W, and the average discharge current is to 20 A (per battery cell). In the case of the lithium battery, applying overcurrent may cause degradation of the battery. Thus, the average discharge current is preferably reduced to 30 A or less. For example, the battery pack 7 or the control circuit 561 may be provided with a current detection section for detecting a current value every predetermined time interval. In this case, for example, when the detected current value exceeds 30 A at a predetermined number of times for, e.g., 10 seconds, overcurrent is determined to stop the discharge. In this case, the gun 3 may be provided with a display section for indicating, using an LED, that the discharge is stopped by the overcurrent. Further, the display section may display a residual capacity of the battery pack 7.

TABLE 1

| 1. Rated | 2. Battery | 3. Battery | 4. Output | Operation |
|---|---|---|---|---|
| Voltage | Capacity | Energy | Power | Time |
| (V) | (Ah) | (Wh: 1 × 2) | (W: 1 × 20 A) | (min) |
| 10.8 | 1.5 | 16.2 | 216 | 5 |
| | 3.0 | 32.4 | | 10 |
| 14.4 | 1.5 | 21.6 | 288 | 6.5 |
| | 3.0 | 43.2 | | 13 |
| 18.0 | 1.5 | 27.0 | 360 | 8 |
| | 3.0 | 54.0 | | 16 |
| 25.2 | 1.5 | 37.8 | 504 | 11 |
| | 3.0 | 75.6 | | 23 |
| 36.0 | 1.5 | 54.0 | 720 | 16 |
| | 2.6 | 93.6 | | 28 |
| | 3.0 | 108.0 | | 32 |

In the present embodiment, the battery pack 7 has a rated voltage of 14.4 V and a battery capacity of 3.0 Ah, and thus a battery energy and output power of the battery pack 7 are 43.2 Wh and 288 W, respectively. Then an operation time is about 13 minutes, which allows consumption of water corresponding to two dedicated tanks 6. This operation time (13 minutes) is a time, for example, capable of cleaning all windows in the second floor of a typical house. Further, the cleaning operation can be performed while raising or dropping the battery voltage.

The high-pressure washing device 1 has cleaning capability of 1 liter per minute in the present embodiment. However, the cleaning capability may be increased in a case where the cleaning capability needs to be increased at the expense of weight of the device 1, or in a case where light weight is preferred over the cleaning capability, and the like. For example, for obtaining an ejection pressure of 3.0 MPa and an ejection flow rate of 3 liter per minute, the battery power requires 600 W calculated from the above equation 3 in case where the efficiency h1 and the efficiency h2 are set to 50%. In this case, a battery pack having a rated voltage of 36.0 V should be selected with reference to Table 1. The 36.0 V battery is used recently in gardening tools and has a weight (about 1.4 kg) that an operator can carry. Further, when cleaning capability is set to 5 liters per minute (battery power 1,000 W) equivalent to conventional devices or 6 liters per minute, two 36.0 V batteries should be used in combination. The battery pack having a rated voltage of 14.4 V and a capacity of 3.0 Ah has a weight of about 530 g, and a battery pack having a rated voltage of 18.0 V and a capacity of 3.0 Ah has a weight of about 700 g. That is, even when more battery power is required and thus a one-size-bigger battery is used, the weight does not become so great that portability is not impaired.

Assuming that the ejection pressure is set to 7 MPa: approximate 450 W battery power is required if the flow rate is set to 1 liter per minute; 1400 W battery power is required if the flow rate is set to 3 liter per minute; and approximate 2300 W battery power is required if the flow rate is set to 5 liter per minute. When the required power is thus increased, a plurality of battery packs may be selected from Table 1 and used in combination. When a plurality of battery packs 7 are used in combination, the weight of the entire product is increased. In this case, however, wheels are provided in the high-pressure washing device 1 so as to allow the device 1 to be dragged, which prevents portability from being impaired.

Further, although the single plunger system is adopted in the present embodiment, the conventional three-plunger system may be adopted if the cleaning capability is prior rather than the consumption of the cleaning liquid, the consumption of power, and the weight. Even in this case, the high-pressure washing device 1 can be driven by the battery pack 7. For example, when the ejection pressure is set to 3 Mpa and the ejection flow rate is set to 1 liter per minute, a battery power of 600 W is required. This 600 W is three times that the required power in the single-plunger system is required simply because the number of the plunger is tripled. In this case, a 36.0 V battery may be used. That is, either the single plunger type or the three-plunger type may be used according to the purpose of usage as long as the high-pressure washing device 1 is driven by the battery pack 7 and performs high-pressure ejection.

Next, the weight of the high-pressure washing device 1 will be considered. Unlike the conventional device, the high-pressure washing device 1 according to the present embodiment uses the battery pack 7 as a drive source of the motor 562. In such a cordless type in which the tank 6 can be carried together with the main body, the weight of the high-pressure washing device 1 is preferably kept as low as possible in terms of portability. In particular, the weight of the battery pack 7 is directly reflected in the weight of the high-pressure washing device 1, and thus the weight of the battery pack 7 is desirably reduced. On the other hand, the present applicant sells FAW-SA series which is the conventional high-pressure washing device driven by a commercial power supply and which has a weight of about 4.5 kg. Thus, the weight of the high-pressure washing device 1 excluding the tank 6, i.e., the weight of the drive section (substantially corresponding to the lower housing 5 of FIG. 1, including the motor 562, the pump 576, and the battery pack 7) is desirably equivalent to the conventional device. When the high-pressure washing device 1 is about 4 kg in total (sum of the weight of the battery pack 7 is 2 kg or less and that of the pump portion (including the pump 576 and motor 562) is about 2 kg), portability thereof can be improved even with a weight equivalent to that of the conventional device. Note that the largest size of the battery pack which the present applicant sells is a 36V battery pack having a weight of about 1.4 kg. Thus, the weights of all the battery packs 7 are less than 2 kg, which satisfies the above condition.

In the high-pressure washing device 1 according to the present embodiment, the weight of the drive section including the battery pack 7, the pump 576, and the motor 562 is about 4 kg equivalent to the weight of the conventional device. When the weight (4 kg) of the tank 6 (containing the cleaning liquid of 4 liters) is added to the weight of the drive section, the entire weight of the high-pressure washing device 1 is not much more than 8 kg. Thus, the portable high-pressure washing device 1 of the cordless type can be achieved.

From above, the minimum power W2 (100 W) and the minimum battery pack power W1 (200 W) each required for the cordless type high-pressure washing device 1 (3.0 MPa, 1 liter per minute) driven by the battery pack 7 are calculated in consideration of the efficiency h1 (50% to 80%) from the battery pack 7 to the motor 562 and efficiency h2 (50% to 80%) from the motor 562 to the pump 576. That is, according to the present embodiment, when the power W2 is set to 100 W or more and the battery pack power W1 is set to 200 W or more, the cordless type high-pressure washing device 1 can be provided. Further, when the battery pack 7 has more than or equal to 200 W output power and more than or equal to 13.3 Wh battery capacity, the cleaning liquid in the dedicated tank 6 can be ejected completely. Furthermore, even when the weight of the high-pressure washing device 1 becomes equivalent to that of the conventional device, existing battery packs can be used. In the present embodiment, a commutator DC motor is employed as the motor 562 and, thus, the conversion efficiency is settled at 50% to 80%. However, when a brushless motor is employed as the motor 562, the conversion efficiency is increased (80% or more), providing power reduction required from the battery pack 7.

As described above, in the high-pressure washing device 1 according to the first embodiment of the present invention, since the motor 562 is driven by power from the battery pack 7, the device 1 can be used without a commercial power supply. This configuration eliminates the need for a power cable to be connected to the high-pressure washing device 1, allowing wide range high-pressure cleaning to be performed without restriction of a length of the power cable. Further, a voltage drop due to presence of the power cable does not occur, providing a stable high-pressure cleaning.

Since the plunger 576A is disposed so as to constitute a part of the compression chamber 573, the plunger 576A is constantly cooled by the cleaning liquid. In addition, in the high-pressure washing device 1 according to the present embodiment, the plunger 576A and the crank 576B connected to the plunger 576A are each made of an aluminum alloy having high heat conductivity. Thus, cooling effect by the cleaning liquid is transmitted over a wide area, thereby preventing a temperature inside the high-pressure washing device 1 from being increased due to heat generated in the motor 562.

Further, the inside of the lower housing 5 is divided by a partitioning plate 54 into the battery chamber 55, the motor chamber 56, and the pump chamber 57, thereby preventing the cleaning liquid in the pump chamber 57 from flowing into the battery chamber 55 and the motor chamber 56. Thus, water damage to components provided in the pump chamber 57, and the battery chamber 55 can be avoided. Further, the tank 6 is provided above the drive section (pump chamber 57 and the like), so that the cleaning liquid flows down into the drive section by its own weight, thereby eliminating the need to additionally provide a pump for pumping up the cleaning liquid.

Further, the battery pack 7 can be detachably attached to the lower housing 5, facilitating charging and replacement of the battery pack 7.

Further, since the battery pack 7 can be used for a power tool, the battery pack 7 used for the power tool can also be applied to the high-pressure washing device 1.

Further, since the battery pack 7 supplies more than or equal to 40 Wh electric power to the motor 562, cleaning operation with a high ejection pressure can be performed for ten minutes or longer.

Further, an average discharge current flowing to the battery cell of the lithium ion battery is set to more than or equal to 20 A, suppressing a degradation thereof.

Further, an average discharge current flowing to the battery cell of the lithium ion battery is set to less than or equal to 30 A, suppressing a degradation thereof.

Further, since the nozzle 31 is formed with an outlet port having a diameter at 0.6 mm, high pressure cleaning with at least 3 Mpa can be achieved.

Further, since the valves 574 and 575 as a check valve are provided respectively at the intake port 571 and the ejection port 572 each connected to the compression chamber 573, a pressure inside the compression chamber 573 is prevented from leaking or decreasing, thereby allowing the pressure of the cleaning liquid to be raised stably in the pump.

Further, since the pump 576 is provided with a single plunger 576A, a consumption of the cleaning liquid can be saved.

Further, since the ejection pressure is pulsated between 3.0 Mpa and 2.4 Mpa, high-pressure cleaning can be performed while suppressing electric power consumption and cleaning liquid consumption.

Further, since the reciprocating pump including a single reciprocating member, generation of pulsation can be performed with a simple structure to suppress electric power consumption and cleaning liquid consumption.

Further, since battery pack 7 outputs more than or equal to 200 W electric power, a high ejection pressure is obtained with a battery pack 7, so that working area is not restricted.

Further, the battery pack 7 is usable for a power tool, which increases versatility and allows use of an existing battery.

Further, since the battery has a weight less than or equal to 2.0 kg, improving portability.

Further, the pump 576 is a reciprocating pump having one or two plungers 576A, so that the drive section is made compact to reduce a size of the device itself.

Further, the plunger 576A is disposed so as to cross the output shaft 562a at substantially right angles (a reciprocating direction of the plunger 576A is substantially perpendicular to the output shaft 562a), so that the drive section can be made more compact than in a conventional configuration in which the plunger is disposed on an extended line of the motor output shaft.

Further, the battery pack 7 is disposed in a space (dead space) on a plane formed by both the output shaft 562a and axis of the plunger 576A, thereby making the drive section compact.

Further, the tank 6 and drive section can be separated from each other, thereby making the drive section itself compact. Further, the drive section can be used for various types of tanks.

Further, the cleaning liquid having a pulsating waveform is fed to the nozzle, thereby suppressing waste of the cleaning liquid.

Further, this configuration reduces the amount of the cleaning liquid to be used in a certain time to two-thirds or less of that in the conventional three-plunger system, thus suppressing the waste of the cleaning liquid. Further, a sliding resistance caused by the reciprocating motion of the plunger 576A can also be reduced to suppress waste of electric power.

Further, this configuration reduces the amount of the cleaning liquid to be used in a certain time to about one-third of that in the conventional three-plunger system, thus suppressing the waste of the cleaning liquid. Further, only one plunger 576A is provided, so that the sliding resistance caused by the reciprocating motion can also be reduced to about one-third. This can enhance efficiency of the reciprocating motion of the plunger 576A, that is, rotating efficiency of the motor 562, thereby suppressing waste of electric power.

The conventional three-plunger system uses a rotating swash plate having a non-uniform thickness. The rotating swash plate is disposed such that a surface thereof confronts the three plungers. Rotating the rotating swash plate in this state causes the plungers contacting the thickened portion of the rotating swash plate to sequentially be pushed, whereby the plungers can be made to reciprocate. In such a configuration, the rotating swash plate and the plunger slide with each other, so that electric power is consumed more. However, in the present invention, rotation of the crank 576B is used in place of the rotating swash plate, thereby suppressing waste of the electric power.

Further, since the cleaning liquid has pulsated waveform whose variation rate is more than or equal to 20% and less than or equal to 60%, the cleaning liquid to be ejected from the nozzle 31 has a pressure for sufficient cleaning capability while suppressing the waste of the cleaning liquid.

Further, the high-pressure washing device 1 is driven by the battery pack 7, so that the high-pressure washing device 1 can be used in an environment where a commercial power supply cannot be obtained. Further, a power cable for acquiring power from the commercial power supply is not required, so that high-pressure cleaning can be performed over a wide area without being restricted by a length of the power cable. Further, a voltage drop due to presence of the power cable does not occur, allowing stable high-pressure cleaning to be performed.

Further, this configuration can suppress waste of the cleaning liquid, thereby allowing cleaning operation to be completed without additional cleaning liquid other than that stored in the container. Further, the tank 6 is accommodated in the tank accommodating portion 41, enhancing portability.

Further, the pump 576 is configured to increase an ejection pressure of the cleaning liquid from the nozzle 31 more than or equal to a pressure of waterworks, thereby allowing a high-pressure washing device which is excellent in portability and which is capable of removing tough stains to be provided.

Further the rubber packing 576c is provided between the casing 576F and the plunger 576A, preventing a pressure of the compression chamber 573 from leaking outside thereof by means of the rubber packing 576c to maintain the pressure level, thereby allowing high-pressure cleaning to be performed.

Further, the high-pressure cleaning liquid is ejected instantaneously, not continuously, thereby suppressing waste of the cleaning liquid as compared to the conventional three-plunger system.

Further, since the pressure of the cleaning liquid is increased more than or equal to 3.0 Mpa, a high-pressure ejection equivalent to the conventional three-plunger system can be performed.

Further, the plunger has a diameter of 5 to 20 mm, a stroke of 3 to 10 mm, and a number of reciprocation of 1000 to 5000 rpm, allowing high pressure cleaning to be performed while suppressing waste of the cleaning liquid.

Further, since a total amount of the cleaning liquid while the variation rate is more than or equal to 20% is one quarter of a total amount of the cleaning liquid during one reciprocating motion of the plunger 576A. This configuration allows suppression of a high-pressure time during one reciprocating motion of the plunger 576A, thereby suppressing waste of the cleaning liquid.

Further, the handle 42a, the tank accommodating portion 41, and the drive section 5 are arranged from top to bottom in this order. This configuration can prevent the tank 6 from being damaged when the high-pressure washing device 1 is overturned or dropped. Further, this configuration can prevent the water from leaking from the tank accommodating portion 41 even when a water-feed inlet is damaged. The high-pressure washing device 1 is provided with the tank 6, thereby eliminating the need for connection with a water hose, which allows use over a wide area.

Further, the handle 42a is connected to the tank accommodating portion 41 so as to be openable and closable. When the handle 42a is closed, an operator can carry the high-pressure washing device 1 by gripping the handle 42a. When the handle 42a is opened, the tank 6 can be taken out.

Further, the tank accommodating portion 41 is detachably connected to the drive section 5, allowing the high-pressure washing device 1 to be connected with a tank having a larger size other than the tank 6 accommodated in the tank accommodating portion 41.

Further, the check valve 64 opens the outflow port 62 upon the attachment of the tank 6, preventing leakage of the cleaning liquid from the container in a state where the container has not been attached to the tank housing portion.

Further, the connecting portion 61 is provided with the check valve 62 and the pressed portion 63 connected to the same. The check valve 64 is open in a state where the pressing portion 45 presses the pressed portion 63. With this configuration, attachment of the tank 6 to the tank accommodating portion 41 automatically opens the check valve 63, so that the cleaning liquid can easily be supplied to the pump 576.

Further, the tank 6 is sandwiched between the lid portion 42 and the receiving portion 46, eliminating the need to provide a member for fixing the tank 6, thereby simplifying the structure.

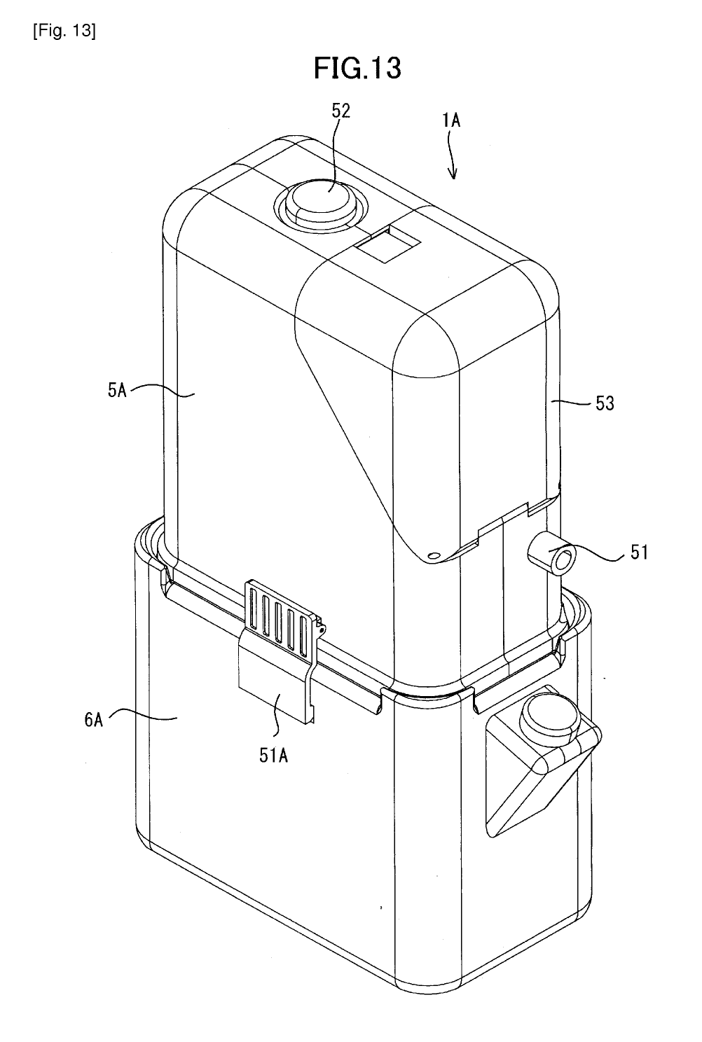

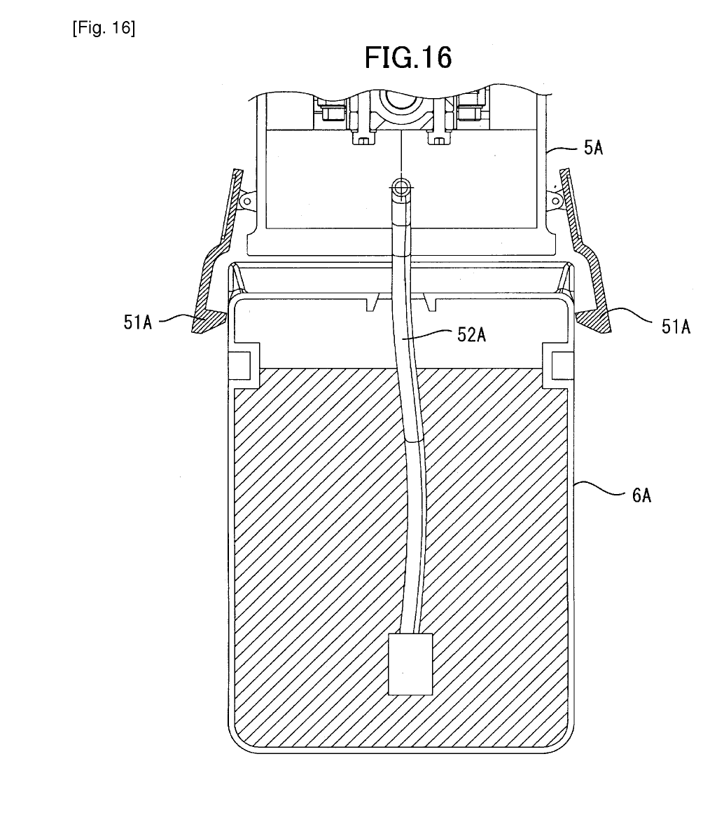

A high-pressure washing device 1A according to a second embodiment of the present invention will be described with reference to FIGS. 13 to 21.

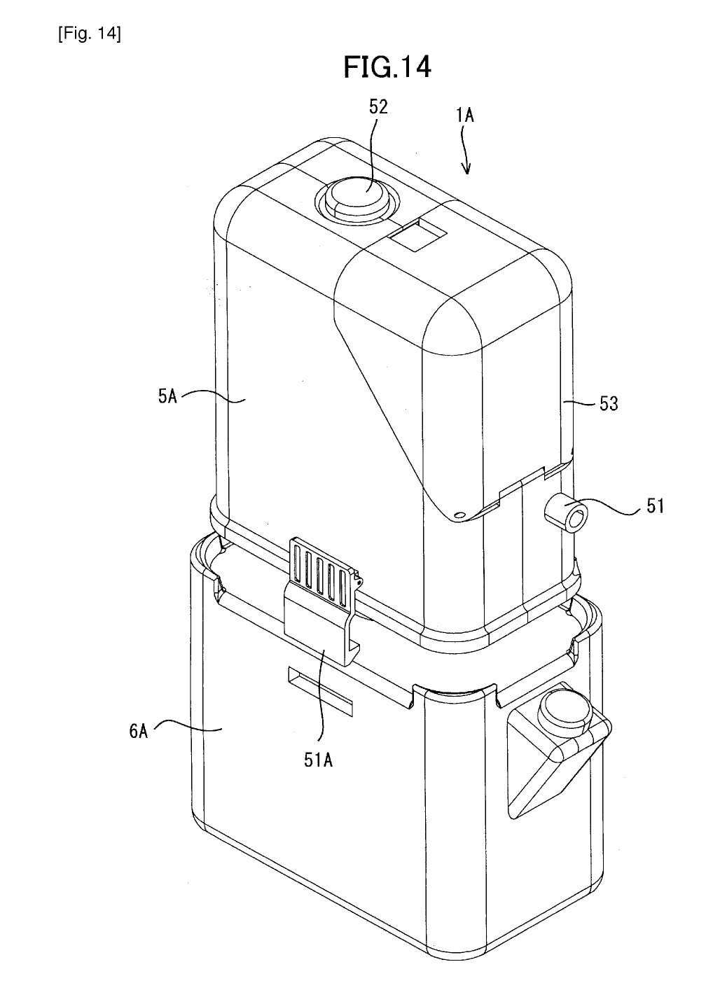

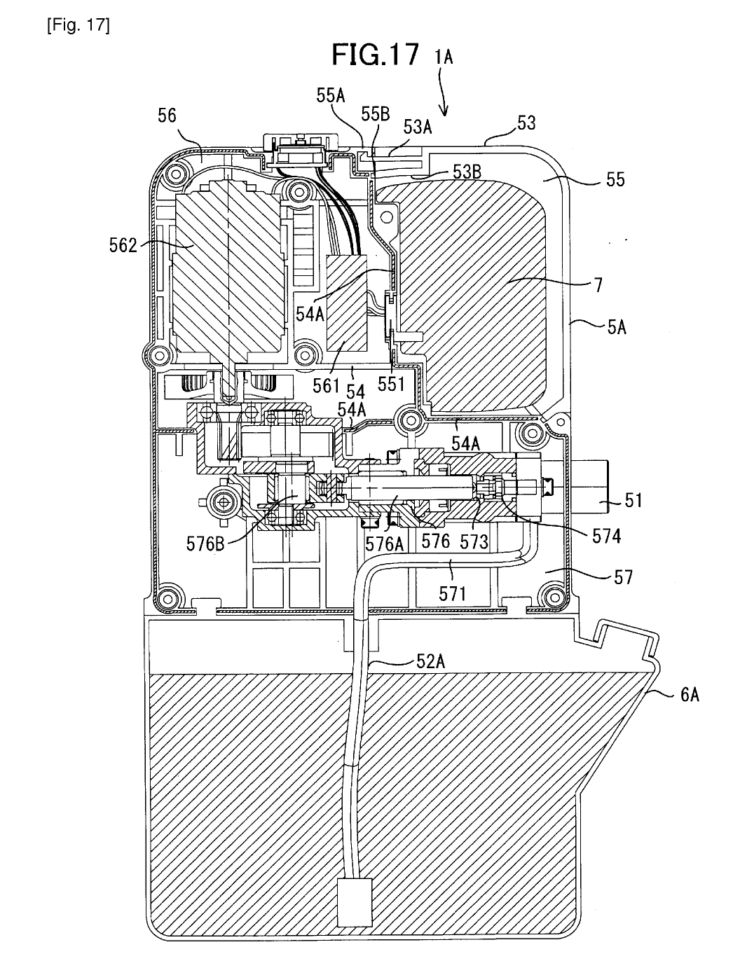

As illustrated in FIGS. 13 and 14, the high-pressure washing device 1A includes a housing 5A and a tank 6A disposed below the housing 5A. The battery chamber 55, the motor chamber 56, and the pump chamber 57 are formed inside the housing 5A (see FIG. 17).

Hereinafter, the same reference numerals are given to the same components as in the first embodiment to avoid duplicated description.

As illustrated in FIGS. 13 to 16, the housing 5A includes a pair of latches 51A. By releasing the pair of latches 51A, the housing 5A and the tank 6A can be separated from each other.

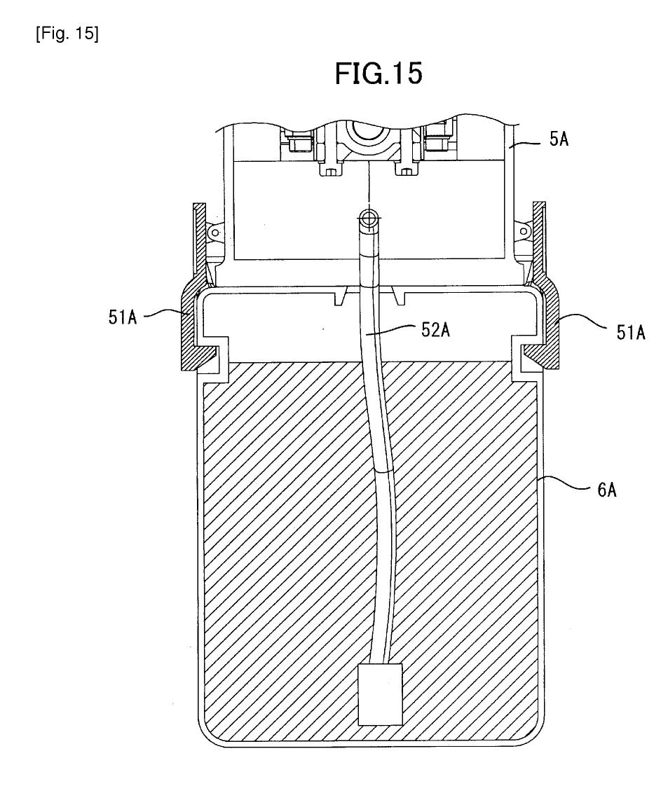

As illustrated in FIGS. 15 to 17, the intake port 571 of the housing 5A is connected with a suction pump 52A. The suction pump 52A extends inside the tank 6A for sucking the cleaning liquid therein.

As illustrated in FIG. 17, seal members 54A (first seal member) are mounted to the partitioning plate 54 so as to prevent more reliably the inflow of the cleaning liquid from the pump chamber 57 into the battery chamber 55 and the motor chamber 56. Specifically, the seal members 54A are provided between the pump chamber 57 and the battery chamber 55, between the pump chamber 57 and the motor chamber 56, and between the battery chamber 55 and the motor chamber 56, avoiding a leakage of the cleaning liquid therebetween. Further the seal members 54A are also provided an outer peripheral wall of the housing 5A to avoid a leakage of the cleaning liquid outside (see oblique line of FIG. 17) and an inflow of rainwater therein. The housing 5A is configured of two parts (left and right portions of FIG. 15), so that the mounting of the seal members 54A can enhance sealability.

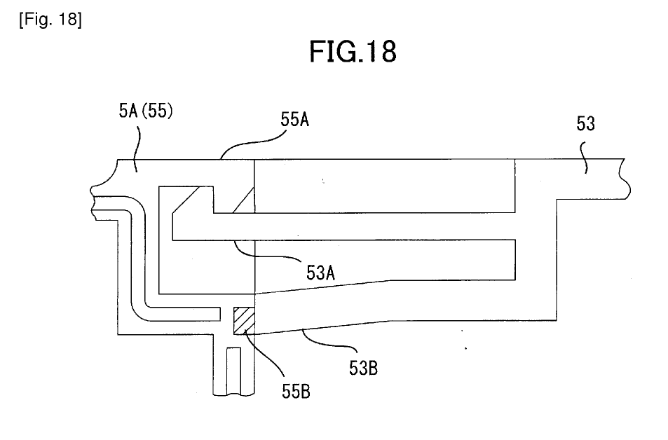

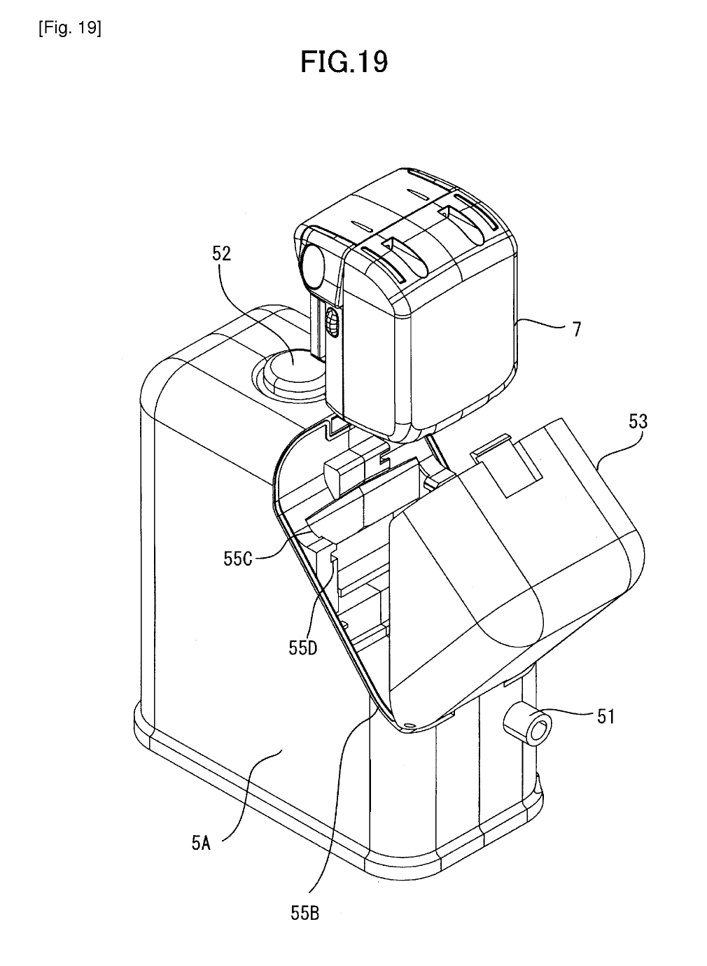

As illustrated in FIGS. 17 and 18, the battery cover 53 is provided with an engaging protrusion 53A and a waterproof protrusion 53B, and the battery chamber 55 is provided with an engaged portion 55A and a seal portion 55B (second seal member). The waterproof protrusion 53B has a tip end portion contactable with the seal portion 55B. As illustrated in FIG. 19, the seal portion 55B is provided at a peripheral portion of an opening upon open the battery cover 53.

When the battery cover 53 is closed, the engaging protrusion 53A is engaged with the engaged portion 55A and, at the same time, the waterproof protrusion 53B is brought into abutment with the seal portion 55B. This prevents more reliably the cleaning liquid from flowing into the battery chamber 55 from outside.

The battery chamber 55 is provided with a guide rail 55C and a latched portion 55D as illustrated in FIG. 19. The battery pack 7 is provided with a guided portion 7A engageable with the guide rail 55C and a latching portion 7B engageable with the latched portion 55D as illustrated in FIG. 20. Further, the battery pack 7 is provided with the terminal 7C for power supply.

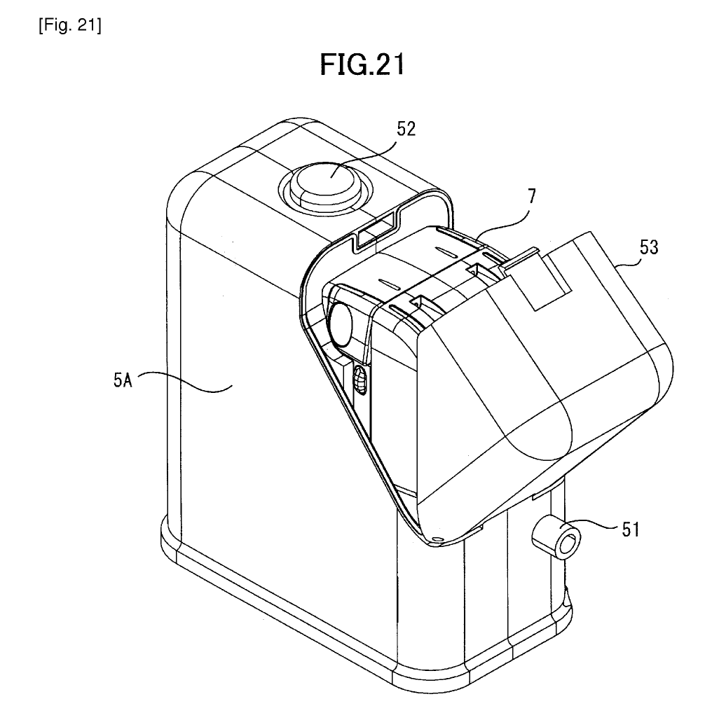

As illustrated in FIG. 19, when attaching the battery pack 7 to the battery chamber 55, first the battery pack 7 is inserted into the battery chamber 55 from above, and then the guided portion 7A of the battery pack 7 is engaged with the guide rail 55C of the battery chamber 55. Pressing downward the battery pack 7 in this state allows the battery pack 7 to be guided to a lowermost point of the battery chamber 55 by the guide rail 55C, as illustrated in FIG. 21. When the battery pack 7 has reached to the lowermost position, the terminal 7C of the battery pack 7 is brought into electrical contact with the electrode 551 of the battery chamber 55. This establishes a state where power can be supplied from the electrode 551 to the control circuit 561 and the motor 562. Further, at this time, the latching portion 7B of the battery pack 7 is engaged with the latched portion 55D of the battery chamber 55, allowing the battery pack 7 to be fixed in the battery chamber 55.

As described above, in the high-pressure washing device 1A according to the present embodiment, the battery chamber 55 and the motor chamber 56 are accommodated in the housing 5A disposed above the tank 6A. Even if the cleaning liquid has leaked from the tank 6A, the cleaning liquid is unlikely to flow in the battery chamber 55 and the motor chamber 56. This prevents the battery pack 7 accommodated in the battery chamber 55, the control circuit 561, and the motor 562 accommodated in the motor chamber 56 from breaking down due to introduction of the cleaning liquid thereinto.

Further, the seal members 54A are mounted to the partitioning plate 54, thereby preventing more reliably the inflow of the cleaning liquid into the battery chamber 55 and the motor chamber 56. Further, the seal portion 55B is provided also in the battery chamber 55, thereby preventing the cleaning liquid or rainwater from being introduced into the battery chamber 55.

The battery pack 7 to be attached to and detached from the battery chamber 55 is guided by the guide rail 55C formed in the battery chamber 55, facilitating attachment of the battery pack 7 to the battery chamber 55.

Further, the battery pack 7 has the latching portion 7B engaged with the latched portion 55D of the battery chamber 55, thereby reliably and easily fixing the battery pack 7 in the battery chamber 55.

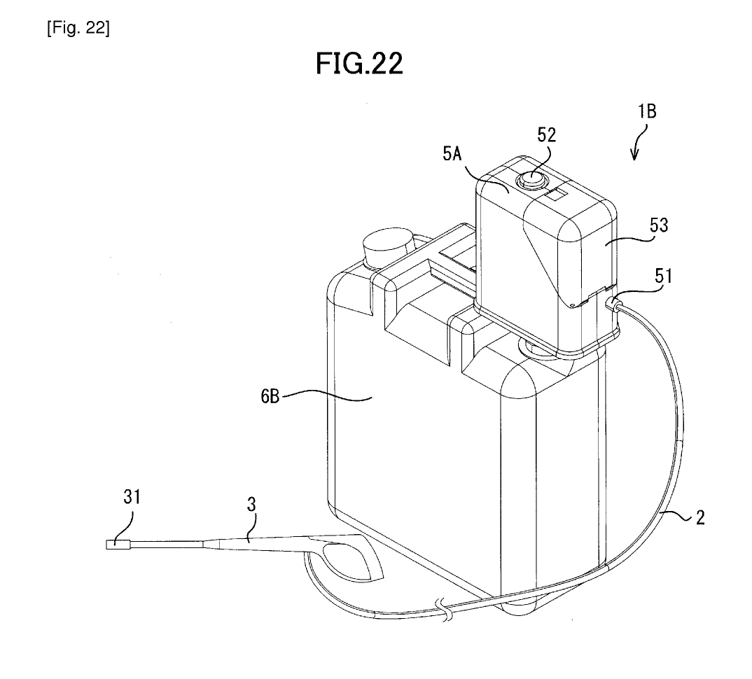

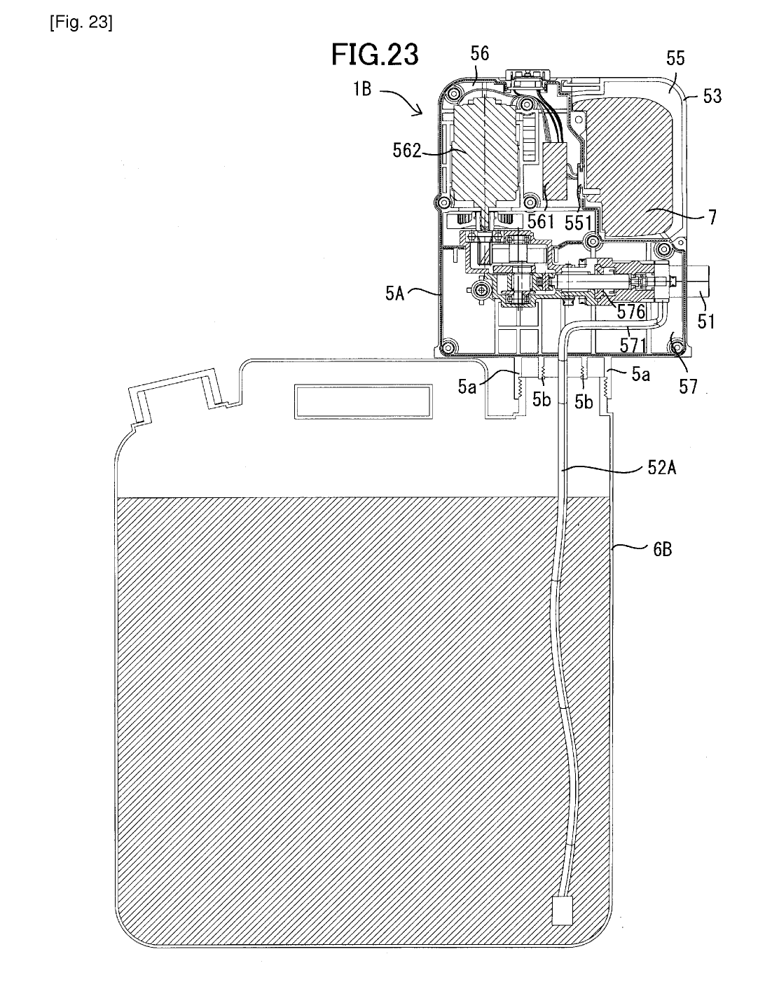

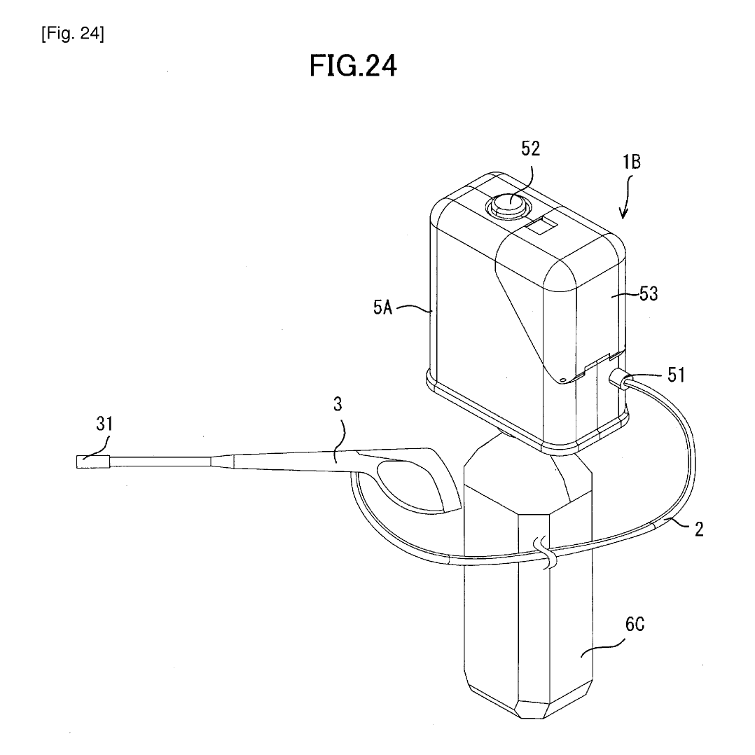

A high-pressure washing device 1B according to a third embodiment of the present invention will be described with reference to FIGS. 22 to 25.

Hereinafter, the same reference numerals are given to the same components as in the first and second embodiments to avoid duplicated description.

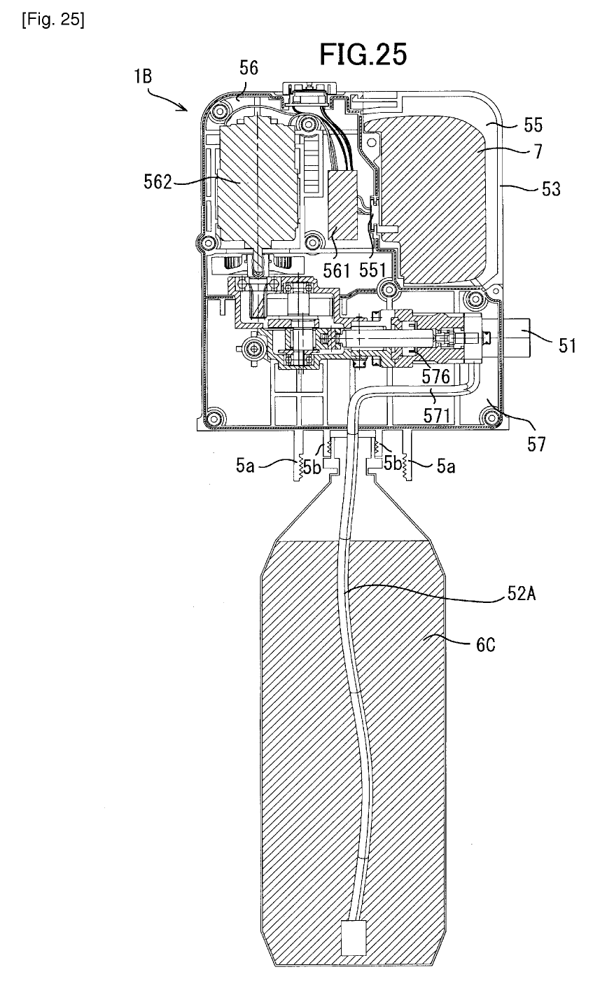

As illustrated in FIGS. 22 and 25, the high-pressure washing device 1B is constituted by only the housing 5A and includes, at a portion below the housing 5A, a first engagement portion 5a engageable with a commercially-available plastic container 6B and a second engagement portion 5b engageable with a commercially-available PET bottle 6C.

More specifically, the first engagement portion 5a is formed into a cylindrical shape and has, in an inner peripheral surface thereof, a female screw portion corresponding to a male screw formed in a spout of the plastic tank 6B (FIG. 23). Similarly, the second engagement portion 5b is formed into a cylindrical shape and has, in an inner peripheral surface thereof, a female screw portion corresponding to a male screw formed in a spout of the commercially-available PET bottle 6C (FIG. 25). The first engagement portion 5a corresponds to a first engaging portion of the present invention. The second engagement portion 5b corresponds to a second engaging portion of the present invention.

As described above, the high-pressure washing device 1B according to the present embodiment does not require the dedicated tank such as the tank 6 of the first embodiment and tank 6A of the second embodiment and can perform high-pressure cleaning by using a commercially-available container.

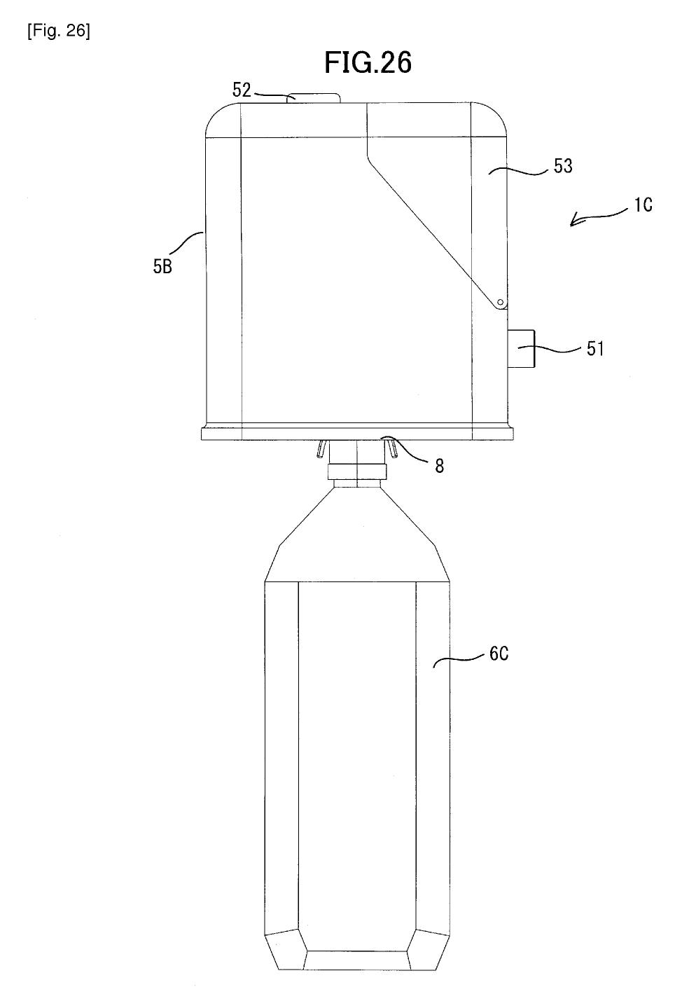

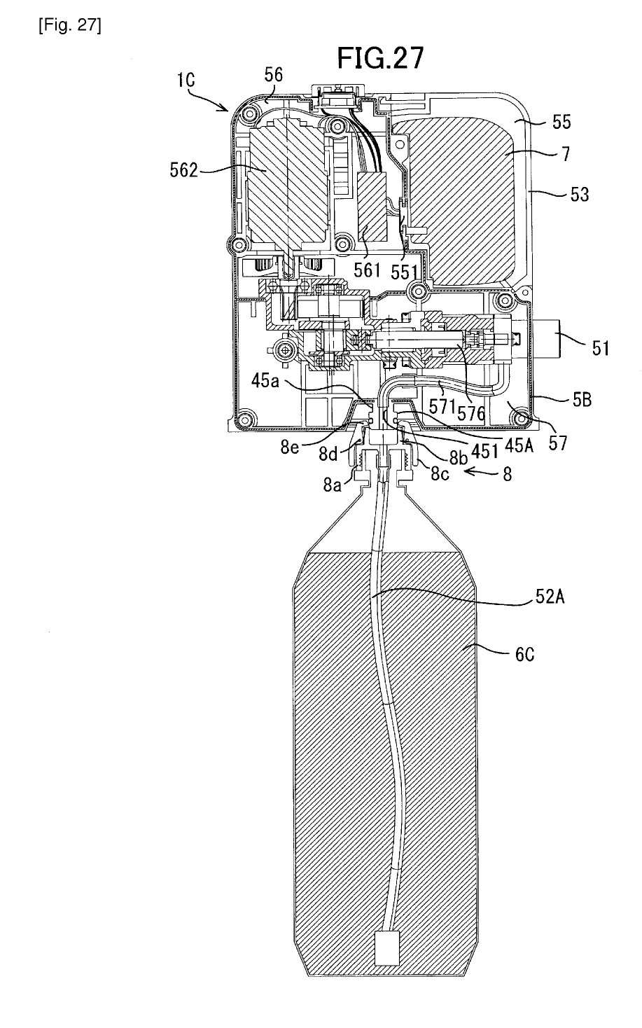

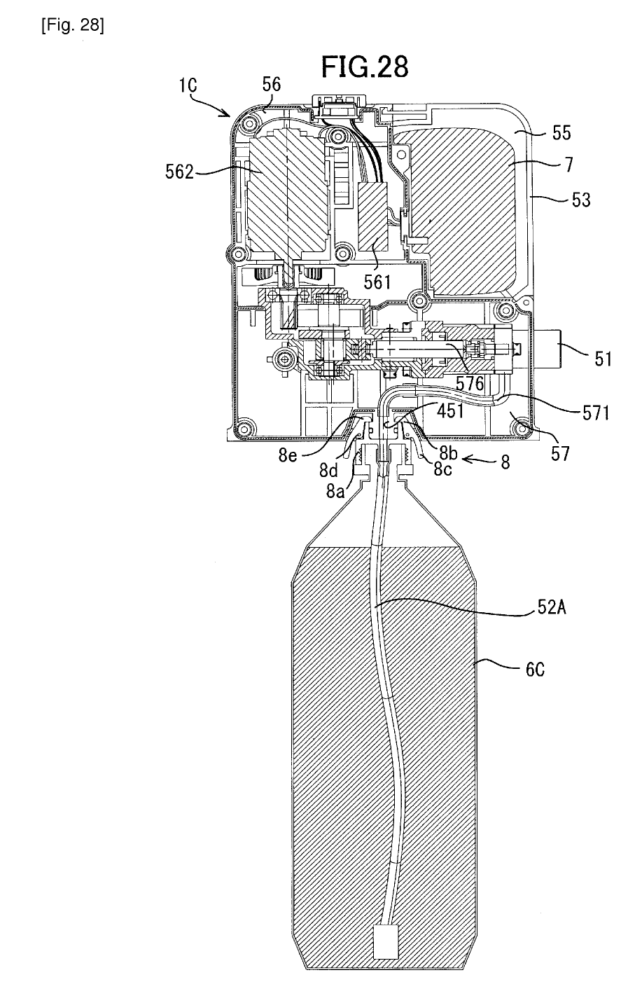

A high-pressure washing device 1C according to a fourth embodiment of the present invention will be described with reference to FIGS. 26 to 28.

Hereinafter, the same reference numerals are given to the same components as in the first to third embodiments to avoid duplicated description.

As illustrated in FIGS. 26 to 28, the high-pressure washing device 1C has an adapter 8 that can connect the inlet 451 of a housing 5B and a commercially-available container.

The adapter 8 includes an engagement portion 8a serving as a tank-side engagement portion, a fitting part 8b serving as a device-side engagement portion, and a pair of locking portions 8c serving as a fixing portion.

The engagement portion 8a is formed into a cylindrical shape and has, in an inner peripheral surface thereof, a female screw portion meshingly engageable with a male screw formed in a spout of the commercially-available container (in the present embodiment, PET bottle 6C).

The fitting part 8b is provided above the engagement portion 8a and has a concave shape opening upward.

Each of the locking portions 8c is pivotally movable about a shaft 8d and has a locking protrusion 8e protruding inward from an upper end of the locking portion 8c. Further, each of the locking portions 8c is biased by a not-illustrated spring so as to cause the locking protrusion 8e to travel inward. The locking portion 8c may be provided on a pressing portion 45A side, not the adapter 8 side as long as the container 6C does not come off from the high-pressure washing device 1C.

The housing 5B includes, at a lower portion thereof, a pressing portion 45A similar to the pressing portion 45 of the first embodiment.

The pressing portion 45A extends in the vertical direction and is formed with the inlet 451 extending in the vertical direction. Further, the pressing portion 45A is formed with a locked portion 45a having a concave shape opening outward at an upper end thereof.

As illustrated in FIG. 27, when attaching the PET bottle 6C to the high-pressure washing device 1C, the engagement portion 8a of the adapter 8 is meshingly engaged with the male screw formed in the spout of the PET bottle 6C, and then the fitting part 8b of the adopter 8 is inserted into the pressing portion 45A of the housing 5B. Thereafter, as illustrated in FIG. 28, when the locking protrusion 8e has been inserted at the same level as the locked portion 45a of the pressing portion 45A, the inwardly biased locking protrusion 8e is engaged with the locked portion 45a, allowing the adapter 8 (PET bottle 6C) to be fixed to the housing 5B.

As described above, in the present embodiment, the high-pressure washing device 1C and commercially-available container can be connected to each other through the adapter 8. That is, the use of a plurality of types of adopters 8 allows the high-pressure cleaning to be performed in various scenes with the high-pressure washing device 1C.

The high-pressure washing device according to the present invention is not limited to the above-described embodiments, but may be variously changed and modified within the scope of the claims of the invention.

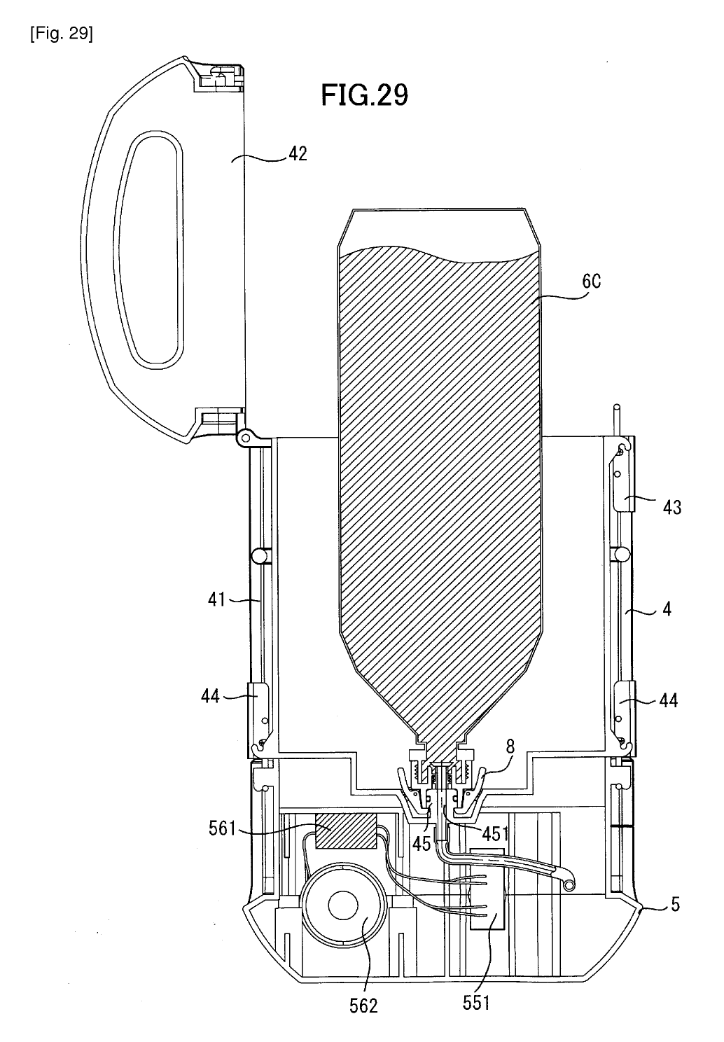

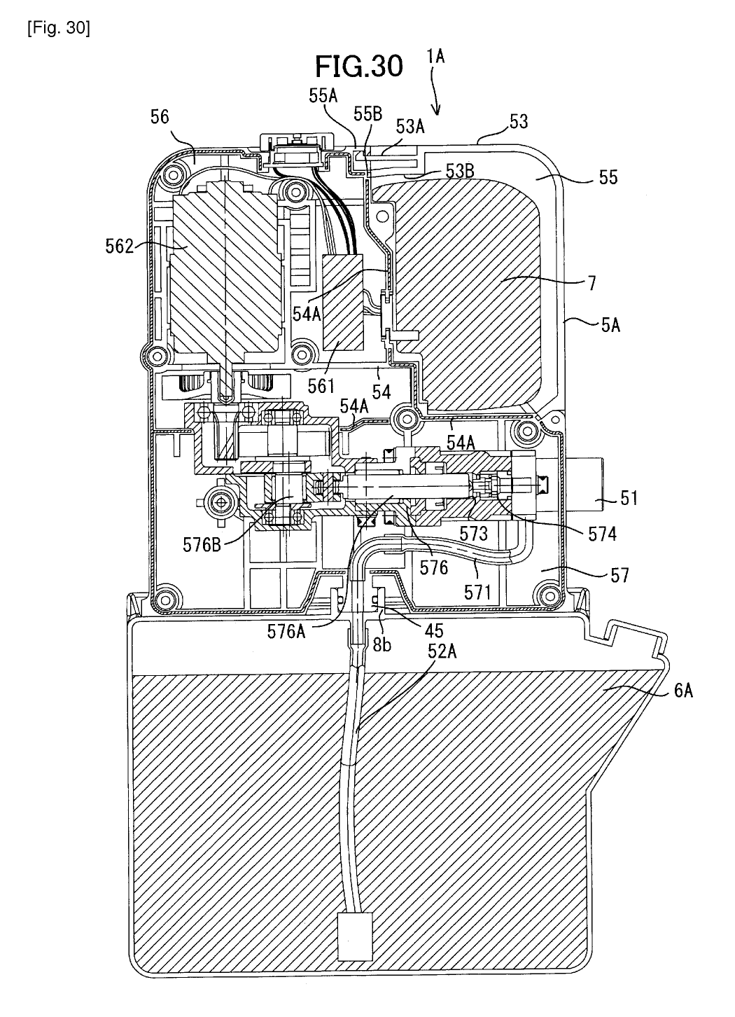

For example, as illustrated in FIG. 29, the adapter 8 of the fourth embodiment may be used to allow various containers to be connected to the pressing portion 45 of the first embodiment. Specifically, the PET bottle 6C is mounted on the pressing portion 45 of the lower housing 5 instead of the tank 6 through the adapter 8. In case where the pressing portion 45 is provided in the lower housing 5, and the lower housing 5 is separated from the upper housing 4 and then turned upside down (such that the pressing portion 45 is located at the bottom), the tank 6A (FIG. 30) can also be connected to the high-pressure washing device 1. With this configuration, the number of types of the containers (e.g., dedicated tank 6, PET bottle 6C, and tank 6A) can be connected to the high-pressure washing device 1.

Further, as illustrated in FIG. 30, the pressing portion 45 of the first embodiment is provided at the lower portion of the housing 5A of the second embodiment, and the fitting part 8b of the fourth embodiment is provided in the tank 6A of the second embodiment so as to allow the housing 5A to be disposed at a predetermined position relative to the tank 6A. This facilitates engagement between the housing 5A and tank 6A by the pair of latches 51A.

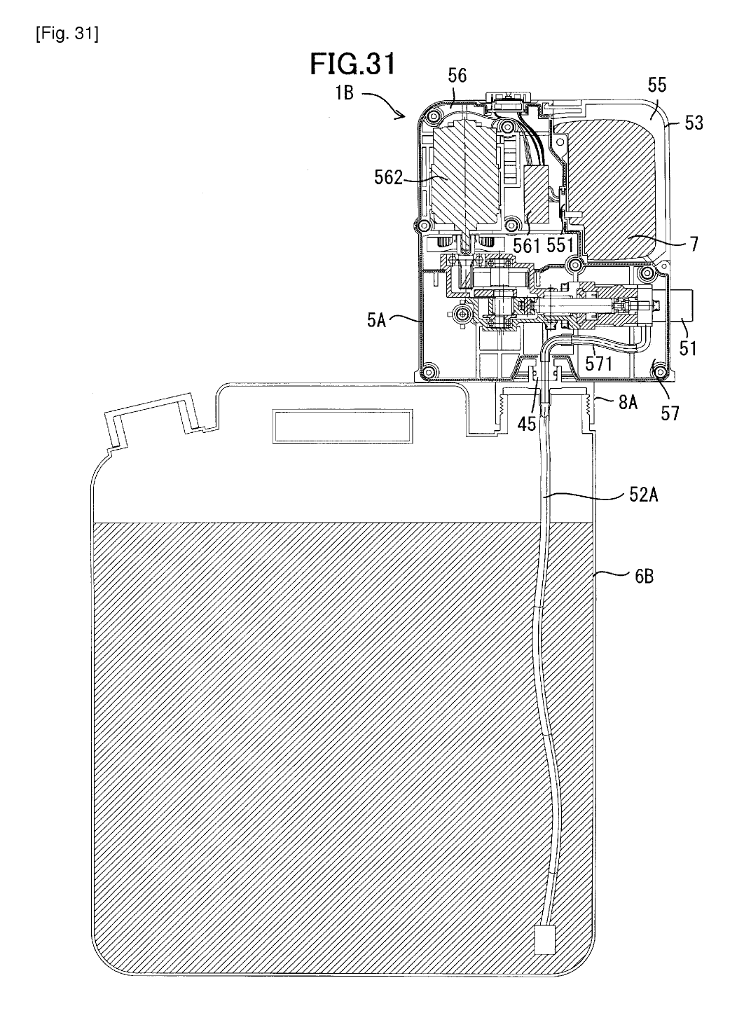

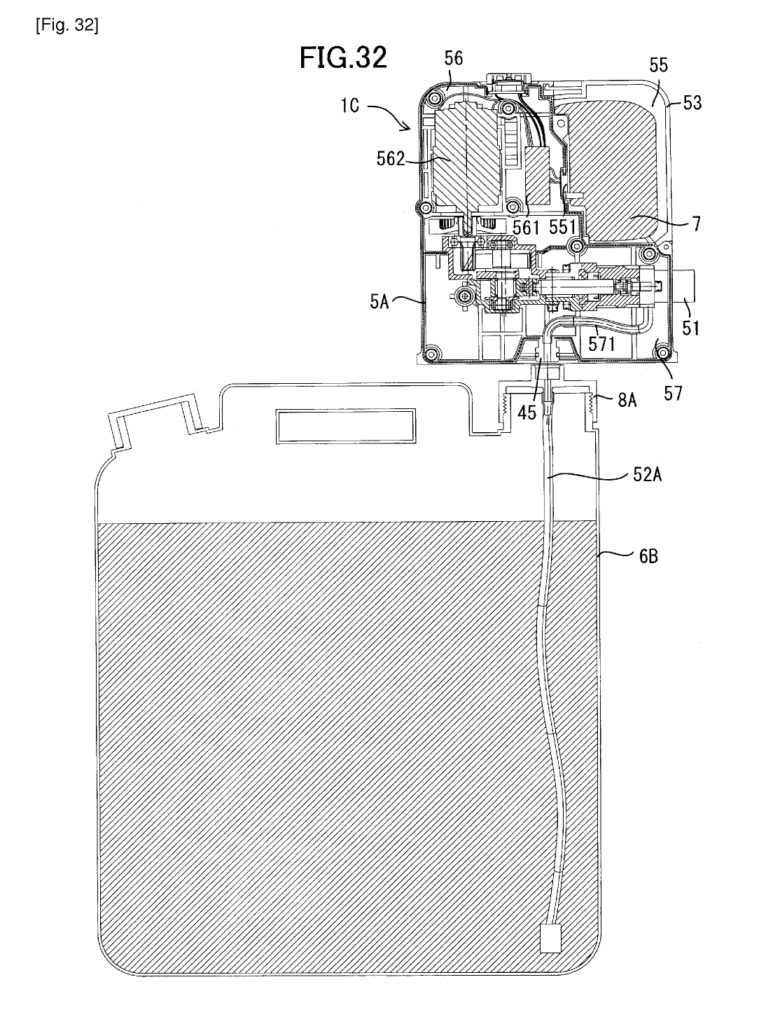

Further, as illustrated in FIGS. 31 and 32, an adapter 8A that does not have the pair of locking portions 8c may be used in place of the adapter 8 of the fourth embodiment. However, presence of the pair of locking portions 8c can fix the tank 6B to the housing 5A more reliably.

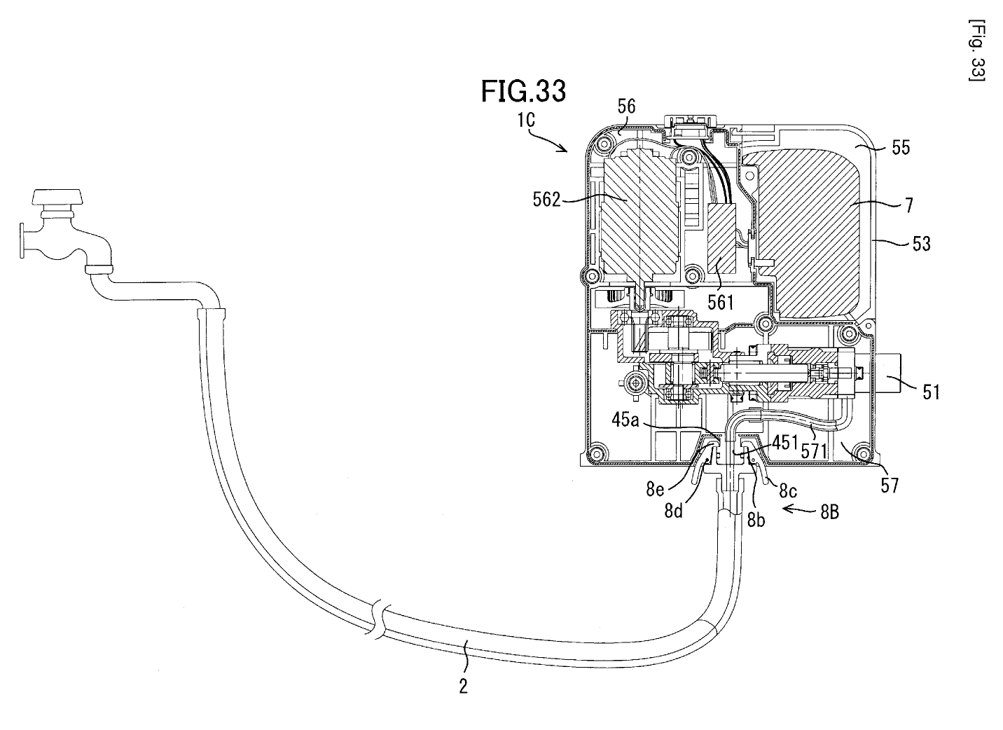

Further, as illustrated in FIG. 33, an adapter 8B engageable with the high-pressure hose 2 may be used in place of the adapter 8 of the fourth embodiment. The adapter 8B includes a water-hose engagement portion 8f serving as a third engagement portion connectable to the water hose. When the power cable and the water hose are compared in terms of length, the power cable is often significantly shorter than the water hose. Thus, even with the above configuration, the object of the present invention, which is to perform high-pressure cleaning over a wide area, can be achieved. Further, an adapter may have a connection port that can alternatively be connected to one of the plastic tank 6B, the commercially-available PET bottle 6C, and the hose 2. That is, the first engagement portion 5a, the second engagement portion 5b, and a connection port for connecting the hose 2 are integrally provided in the adapter so as to be detachably attached to the pressing portion 45. Specifically, as shown in FIG. 42, the adapter 8C includes an engagement portion 8g (second engagement part) engageable to the commercially-available plastic container 6B, in addition to the engagement portion 8a (first engagement part). This configuration allows various water sources (PET bottle, plastic tank, water hose, etc.) to be used with one adapter. Further, if the diameters of the pressing portions 45 and 45A are equal to each other, a plurality of types of the adapters does not need to prepare. The diameter of the pressing portion 45 is preferably set to a diameter capable of attaching the water hose. As illustrated in FIG. 42, an adapter 8C may be employed. One of the adapters 8, 8A, 8B, and 8C corresponds to the first adapter of the present invention, and one of the remaining adapters corresponds to a second adapter of the present invention.

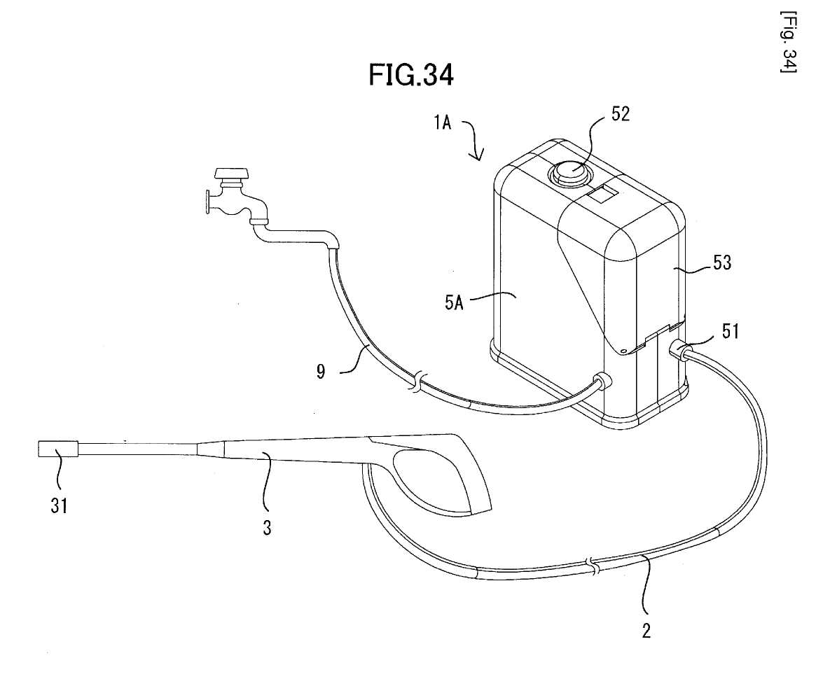

For the similar reason, as illustrated in FIG. 34, a configuration may be adopted in which a water hose 9 can be attached to the housing 5A.

Further, the first engagement portion 5a and the second engagement portion 5b are provided at the high-pressure washing device 5B. This configuration allows high-pressure washing device 1B to be performed using a plurality of types of tanks. That is, a plurality of tanks can be used depending on an amount of the cleaning liquid to be used.

Further, the adapters 8 may be provided with a check valve, a fitting portion, a pressed portion, and formed with an outflow port. With this configuration, the adapter is removed when the cleaning liquid is poured into the tank 6, so that the cleaning liquid can be easily poured into the tank, and leakage of the cleaning liquid from the outlet port can be prevented during the water pouring.

Further, the intake valve 6a is provided at the bottom surface 6A of the tank 6, preventing the inside of the tank 6 from being brought into a negative pressure during cleaning operation, thereby preventing the tank 6 from being damaged.

Further, the adapter includes the engagement portions 8a and 8g, allowing connection to a plurality of containers. Thus, various tanks can be selected depending on the operation usage pattern, which enhances workability.

Further, the tank 6A is located below the housing 5A, so that even if the cleaning liquid leaks from the tank 6A, the cleaning liquid is unlikely to flow inside the housing 5A. This prevents the motor 562 and pump 576 from breaking down due to introduction of the cleaning liquid thereinto.

Further, the high-pressure washing device 1B is provided with the first and second engagement portions 5a, 5b. This configuration allows high-pressure washing device 1B to be performed using a plurality of types of tanks, in addition to a dedicated container. That is, a plurality of tanks can be used depending on an amount of the cleaning liquid to be used.

Further, each of the adapters 8, 8A, 8B, and 8C has the same fitting portion 8b. This configuration allows use of various sizes of tanks, increasing workability. Further, this eliminates the need of providing a connection portion for each adapter, which simplifies the device structure and prevents an increase in size of the entire device.

Further, the adapter is provided with the locking portion 8c, allowing the high-pressure washing device and the tank to be engaged with each other reliably by means of the locking portion 8c.

Further, a protrusion of the locking portion 8c is engaged with the locked portion 45a, so that the adapter is fixed to the pressing portion 45. This configuration allows the tank to be engaged with the locked portion 45a reliably by means of the protrusion, thereby preventing unexpected coming off of the tank.

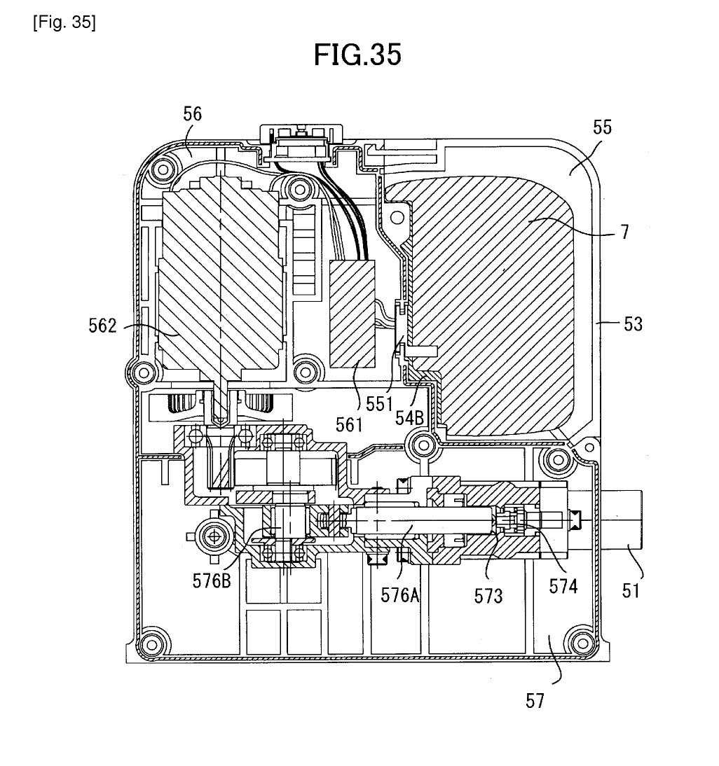

Further, in the second embodiment, an additional seal member 54B (third seal member) may be provided between the electrode 551 of the battery chamber 55 and the battery pack 7, as illustrated in FIG. 35. This configuration prevents trouble such as short-circuit due to inflow of the cleaning liquid between the electrode 551 and the battery pack 7. Further, mounting a seal member also to the battery cover 53 also prevents inflow of the cleaning liquid into the battery chamber 55 from outside. Further, providing the seal members 54A, 54B, and 55B in the first embodiment exerts higher effect in a case where the tank 6 is disposed above the drive section (motor and pump).

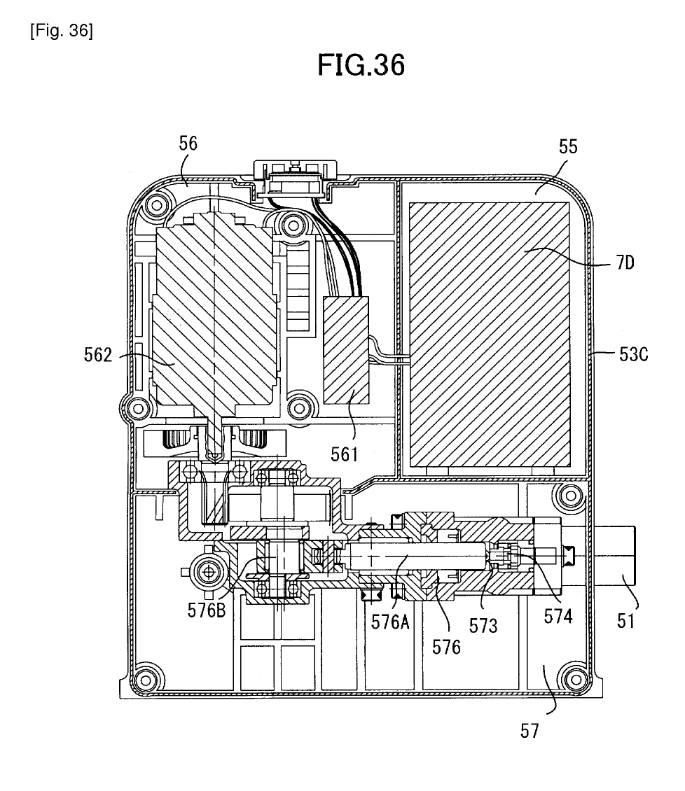

Further, as illustrated in FIG. 36, a battery pack 7D need not be detachably attached to the battery chamber 55, and the battery cover 53 need not be openably mounted. Further, the battery pack also need not be detachably attached to a power tool. That is, a dedicated battery may be incorporated in the housing, or a battery pack intended for exclusive use with the high-pressure washing device 1 may be provided. In the case where the dedicated battery or battery pack is incorporated, a charging terminal should be provided in the housing so as to charge the dedicated battery or battery pack. In this case, a waterproof structure (for example, the charging terminal is covered by a lid provided with a seal member) should be adopted for the charging terminal.

The pump 576 is not limited to a type described in the above embodiments but may be, e.g., a piston pump.

Although the cleaning liquid to be ejected from the nozzle 31 has a pressure of 3 MPa to 7 MPa in the above embodiments, the minimum pressure need not be 3.0 MPa but may be any value as long as cleaning operation can be effectively performed. Although the pressure of 3.0 MPa has experimentally been calculated as the lowest pressure at which stains can be removed, this value can be changed in accordance with a diameter of the nozzle. For example, the minimum pressure may be set to 2.5 MPa, provided that cleaning can be effectively performed.

Further, attaching a shoulder belt to the high-pressure washing device according to the present invention facilitates wide area high-pressure cleaning. For example, as illustrated in FIG. 1, a pair of hooks 4a (belt attachment portion) are provided on a side surface of the upper housing 4, and the shoulder belt is attached to the hooks 4a as needed. This facilitates carrying of the high-pressure washing device. Further, an operator can perform cleaning while putting the high-pressure washing device on his or her shoulder, enhancing workability. Alternatively, the device may be hooked to a waist band of the operator, or carried on the back thereof.

Although the cleaning liquid container is provided above or below the housing in the above embodiments, the container may be provided on a side of the housing. In this case, when an opening portion (outlet port) of the container faces downward, the pump may have a configuration as illustrated in FIG. 1, and when the opening portion faces upward, the pump may have a configuration as illustrated in FIG. 13.

### REFERENCE SIGNS LIST

1-1C high-pressure washing device
2 hose
3 gun
4 upper housing
5 housing
5A, 5B housing
5a first engagement portion
5b second engagement portion
6 tank
6A tank
6B plastic tank
6C PET bottle
7 battery pack
7A guided portion
7B latching portion
7C terminal
8-8C adapter
8a engagement portion
8b fitting portion
8c locking portion
8d shaft
8e locking protrusion
9 water hose
31 nozzle
41 main body
42 lid portion
43 upper latch
44 lower latch
45, 45A pressing portion
45a locked portion
51 latch
51A latch
52 start switch
52A pump
53 battery cover
53A engaging protrusion
53B waterproof protrusion
54 partitioning plate
54A, 54B seal member
55 battery chamber
55A engaged portion
55B seal portion
55C guide rail
55D latched portion
56 motor chamber
57 pump chamber
61 connecting portion
62 outflow port
63 pressed portion
64 check valve
65 fitting portion
451 inlet
551 electrode
561 control circuit
562 motor
571 intake port
572 ejection port
573 compression chamber
574 intake-side valve
575 ejection-side valve
576 pump
576A plunger
576B crank

1. A high-pressure washing device comprising:
A motor; and
a nozzle configured to eject a high-pressure cleaning liquid,
wherein the cleaning liquid ejected from the nozzle has a pulsation pressure between a maximum pressure and a minimum pressure 20% to 60% smaller than the maximum pressure, and a variation rate of the pulsation pressure is more than or equal to 20%,
wherein a rotating speed of the motor is controlled such that the maximum pressure and the minimum pressure are alternately generated.

2. The high-pressure washing device according to claim 1, wherein the maximum pressure is more than or equal to 3.0 Mpa, and the minimum pressure is less than or equal to 2.4 Mpa.

3. The high-pressure washing device according to claim 1, wherein a total amount of the cleaning liquid ejected from the nozzle while an ejection pressure of the cleaning liquid is more than or equal to 2.4 Mpa is more than or equal to three times as large as a total amount of the cleaning liquid while the ejection pressure is less than 2.4 Mpa.

4. The high-pressure washing device according to claim 1, further comprising:
a reciprocating pump configured to be driven by the motor to eject the high-pressure cleaning liquid from the nozzle, the reciprocating pump including a single reciprocating member,
wherein a drive of the reciprocating pump causes the cleaning liquid to be pulsated.

5. The high-pressure washing device according to claim 4, further comprising a battery configured to supply electric power to the motor, the battery being configured to output more than or equal to 200 W electric power.

6. The high-pressure washing device according to claim 5, wherein the battery is usable for a power tool.

7. The high-pressure washing device according to claim 5, wherein the battery has a weight less than or equal to 2.0 kg.

8. A high-pressure washing device comprising:
a nozzle configured to eject a high-pressure cleaning liquid;
a motor; and
a drive section including a pump,
wherein the pump is a reciprocating pump having one or two reciprocating members driven by the motor.

9. The high-pressure washing device according to claim 8, wherein the motor has an output shaft extending in a first direction and the reciprocating member defines an axis extending in a second direction, the first direction being substantially perpendicular to the second direction.

10. The high-pressure washing device according to claim 9, further comprising a battery configured to supply electric power to the motor,
wherein the output shaft and the axis are located on a plane, the plane defining a rectangular region having four sides, each of the output shaft and the axis comprising one of the four sides,
wherein the battery is disposed at the rectangular region as viewed from a direction orthogonal to the plane.

11. The high-pressure washing device according to claim 10, wherein the driving section further comprises a housing for accommodating therein the motor, the reciprocating pump, and the battery, the nozzle being connected to the housing,
the high-pressure washing device further comprising a tank detachably mounted to the drive section, the tank being configured to accommodate therein the cleaning liquid.

12. The high-pressure washing device according to claim 8, wherein an ejection pressure of the cleaning liquid ejected from the nozzle is pulsated within a prescribed range.

13. The high-pressure washing device according to claim 8, wherein the reciprocating pump has one reciprocating member.

14. The high-pressure washing device according to claim 8, wherein the drive section further comprises a crank configured to be eccentrically driven by the motor.

15. The high-pressure washing device according to claim 8, wherein the cleaning liquid ejected from the nozzle has a pulsation pressure, and a variation rate of the pulsation pressure is more than or equal to 20%.

16. The high-pressure washing device according to claim 8, wherein the cleaning liquid ejected from the nozzle has a pulsation pressure, and a variation rate of the pulsation pressure is less than or equal to 60%.

17. The high-pressure washing device according to claim 8, further comprising a battery configured to supply electric power to the motor to drive the motor.

18. The high-pressure washing device according to claim 8, further comprising:
a housing configured to accommodate therein the motor and the pump; and
a tank configured to accommodate therein the cleaning liquid, the tank being detachably accommodated in the housing.

19. The high-pressure washing device according to claim 8, wherein the pump is configured to increase an ejection pressure of the cleaning liquid from the nozzle more than or equal to a pressure of waterworks.

20. The high-pressure washing device according to claim 8, wherein the drive section further comprises a compression section configured to accumulate the cleaning liquid, the reciprocating member being configured to reciprocatingly move so as to change a volume of the compression section,
wherein the pump further includes:
a casing for accommodating the reciprocating member; and
a first seal member provided between the casing and an outer peripheral surface of the reciprocating member.

21. A high-pressure washing device comprising:
a nozzle configured to eject a high-pressure cleaning liquid;
a motor; and
a pump configured to be reciprocatingly driven by the motor to convey the cleaning liquid to the nozzle,
the pump being configured to instantaneously eject from the nozzle the cleaning liquid having a pressure more than or equal to a pressure of waterworks.

22. The high-pressure washing device according to claim 21, wherein the pump is configured to increase the pressure of the cleaning liquid more than or equal to 3.0 Mpa, the nozzle ejecting the increased cleaning liquid.

23. The high-pressure washing device according to claim 21, wherein the pump includes a plunger having a substantially cylindrical shape, the plunger having a diameter of 5 to 20 mm, a stroke of 3 to 10 mm, and a number of reciprocation of 1000 to 5000 rpm.

24. The high-pressure washing device according to claim 21, wherein the cleaning liquid ejected from the nozzle has a pulsation pressure, and a variation rate of the pulsation pressure is more than or equal to 20%,
wherein the pump includes a plunger configured to reciprocatingly move,
wherein a total amount of the cleaning liquid while the variation rate is more than or equal to 20% is substantially three quarter of a total amount of the cleaning liquid during one reciprocating motion of the plunger.

25. A washing device configured to eject a cleaning liquid from a nozzle, the washing device comprising:
a handle portion;
a drive section configured to be driven so as to eject the cleaning liquid from the nozzle; and
a tank accommodating portion configured to accommodate a tank therein;
the tank accommodating portion being disposed below the handle section,
wherein the drive section is disposed below the tank accommodating section; and
the handle portion, the tank accommodating portion, and the drive section are arranged from top to bottom in this order.

26. The washing device according to claim 25, wherein the tank accommodating portion is formed with an opening through which the tank is attached thereto,
wherein the handle portion is connected to the tank accommodating portion so as to be openable and closable the opening.

27. The washing device according to claim 25, wherein the tank accommodating portion is detachably connected to the drive section.

28. The washing device according to claim 25, wherein the tank accommodating portion is detachably connected to a first tank formed with a first opening and a second tank formed with a second opening,
wherein the tank accommodating portion includes a first engaging portion engageable with the first opening and a second engaging portion engageable with the second opening.

29. The washing device according to claim 25 further comprising:
a motor configured to drive the drive section; and
a battery configured to supply electric power to the motor, the motor being drive by the electric power.

30. The washing device according to claim 25, further comprising a pump configured to convey the cleaning liquid to the nozzle,
wherein the tank is formed with an outflow port,
wherein the tank accommodating portion includes a connecting portion configured to be connected to the outflow port and in fluid communication with the pump.

31. The washing device according to claim 30, wherein the tank includes a fitting portion configured to be fitted to the connecting portion,
wherein the connecting portion includes a second seal member configured to be in sealing contact with the fitting portion when the fitting portion is fitted to the connecting portion.

32. The washing device according to claim 30, wherein the outflow port is in confrontation with the connecting portion when the tank is attached to the tank accommodating portion,
wherein the tank includes a valve portion configured to open and close the outflow port,
wherein the valve portion opens the outflow port when the tank is attached to the tank accommodating portion.

33. The washing device according to claim 32, wherein the valve portion includes a valve body configured to close the outflow port and a pressed portion connected to the valve body,
wherein the valve portion opens the outflow port when the pressed portion is pressed by the connecting portion.

34. The washing device according to claim 32, wherein the tank is formed with an opening portion through which the cleaning liquid is poured to the tank,
the washing device further comprising an adapter detachably connected to the opening portion to close the opening portion,
wherein the fitting portion, the outflow port, and the valve portion are provided at the adaptor.

35. The washing device according to claim 25, wherein the tank is formed with an opening portion through which the cleaning liquid is poured to the tank and an air inlet for introducing air therein, the tank having a first surface with which the opening portion is formed and a second surface with which the air inlet is formed, the tank including an air inlet member configured to open and close the air inlet,
wherein the air inlet member closes the air inlet when the cleaning liquid is poured to the tank, whereas the air inlet member opens the air inlet when the tank is attached to the tank accommodating portion.

36. The washing device according to claim 30, wherein the tank accommodating portion is formed with an opening through which the tank is accommodated therein,
wherein the tank is accommodated in the tank accommodating portion so as to be sandwiched between the tank accommodating portion and the handle portion.

37. The washing device according to claim 31, wherein the connecting portion is connectable to at least one of a first tank and a second tank.

38. The washing device according to claim 37, further comprising an adapter configured to connect the connecting portion to at least one of the first tank and the second tank,
wherein the first tank is formed with a first opening and the second tank is formed with a second opening, the adapter including a first engagement portion engageable with the first opening and a second engagement portion engageable with the second opening.

39. A washing device comprising:
a nozzle configured to eject a cleaning liquid;
a housing,
a motor accommodated in the housing; and
a pump configured to be driven by the motor,
wherein the housing is configured to detachably receive a tank for accommodating therein the cleaning liquid, and the pump conveys the cleaning liquid accommodated in the tank to the nozzle.

40. The washing device according to claim 39, wherein the tank is located below the housing upon the attachment to the housing.

41. The washing device according to claim 39, wherein the housing detachably receives a first tank formed with a first opening and a second tank formed with a second opening having a size different from a size of the first opening,
wherein the housing includes a first engaging portion engageable with the first opening and a second engaging portion engageable with the second opening.

42. The washing device according to claim 39, wherein the motor is driven by electric power supplied from a battery.

43. A washing device comprising:
a motor;
a pump driven by the motor;
a housing for accommodating therein the motor and the pump; and
a connecting portion provided at the housing, the connecting portion being configured to be connected to a tank for accommodating therein a cleaning liquid,
wherein the housing is configured to detachably receive a plurality of types of tanks; and
the connecting portion is connectable to the plurality of types of tanks.

44. A washing device configured to eject a cleaning liquid from a nozzle, the washing device comprising:
a tank configured to accommodate therein a cleaning liquid;
a connecting portion configured to be connected to the tank; and
an adapter configured to connect the tank to the connecting portion;
wherein the tank is formed with an opening portion; and
the adapter includes a tank-side engagement portion engageable with the opening portion and a device-side engagement portion engageable with the connecting portion.

45. The washing device according to claim 44, wherein the tank-side engagement portion is engageable with a plurality of types of tanks including a first tank formed with a first opening and a second tank formed with a second opening, the first opening has a size different from a size of the second opening,
wherein the tank-side engagement portion includes a first engagement portion engageable with the first opening and a second engagement portion engageable with the second opening.

46. The washing device according to claim 45, wherein the tank-side engagement portion further includes a third engagement portion connectable to a water hose.

47. A washing device configured to eject a cleaning liquid from a nozzle, the washing device comprising:
a tank configured to accommodate therein the cleaning liquid; and
an adapter unit configured to be connected to the tank,
the adapter unit being connectable to a plurality of types of tanks including a first tank formed with a first opening, and a second tank formed with a second opening having a size different from a size of the first opening,
the adapter unit including a first adapter connectable to the first tank and a second adapter connectable to the second tank.

48. The washing device according to claim 47, wherein each of the first and the second adapters includes a tank-side engagement portion engageable with the tank and a device-side engagement portion engageable with the washing device,
wherein the device-side engagement portion of the first adapter has a same shape as that of the device-side engagement portion of the second adapter in spite of a shape of the tank-side engagement portion.

49. An adapter configured to connect a tank for accommodating a cleaning liquid to a washing device configured to eject the cleaning liquid form a nozzle, the tank is formed with an opening portion;
the adapter comprising:
a tank-side engagement portion engageable with the opening portion; and
a device-side engagement portion engageable with the washing device.

50. The adapter according to claim 49, further comprising a fixing portion configured to fix an engagement between the washing device and the device-side engagement portion.

51. The adapter according to claim 49, wherein the washing device includes a connecting portion configured to be connected to the device-side engagement portion and a locked portion,
wherein the device-side engagement portion includes a fitting portion configured to be fitted to the connecting portion,
the adapter further comprising a fixing portion including a protrusion engageable with the locked portion,
wherein the device-side engagement portion is engaged with the connecting portion when the protrusion is engaged with the locked portion.

52. The adapter according to claim 51, wherein the fitting portion has an inner peripheral surface and includes a seal member, the connecting portion having an outer peripheral surface,
wherein the seal member is provided between the inner peripheral surface and the outer peripheral surface when the fitting portion is fitted to the connecting portion.

53. The adapter according to claim 49, wherein a tank-side engagement portion is engageable with a plurality of types of tanks, the plurality of types of tanks including a first tank formed with a first opening and a second tank formed with a second opening having a size different from a size of the first opening,
the adapter further comprising a first engaging part engageable with the first opening and a second engaging part engageable with the second opening.
